(19) United States
(12) Patent Application Publication
(10) Pub. No.: US 2024/0057060 A1
(43) Pub. Date: Feb. 15, 2024

(54) METHOD FOR ALLOCATION OF MULTI-PUSCH CONFIGURED GRANTS AND DEVICES USING THE SAME

(71) Applicant: FG Innovation Company Limited, Tuen Mun (HK)

(72) Inventors: YEN-HUA LI, Taipei (TW); CHIA-HSIN LAI, Taipei (TW); HSIN-HSI TSAI, Taipei (TW)

(21) Appl. No.: 18/233,213

(22) Filed: Aug. 11, 2023

Related U.S. Application Data
(60) Provisional application No. 63/397,555, filed on Aug. 12, 2022.

(51) Int. Cl. H04W 72/12; H04L 5/14

(52) U.S. Cl. CPC H04W 72/12; H04L 5/14

(57) ABSTRACT

Methods and devices for allowing more than one physical uplink shared channels (PUSCHs) in each of a plurality of configured grant (CG) periods are provided. The method includes receiving, from a base station (BS), a CG configuration for configuring the plurality of CG periods; receiving, from the BS, a radio resource control (RRC) configuration including a first parameter; and determining, for each of the plurality of CG periods, that a CG PUSCH occasion exists in each of a number of consecutive slots within the corresponding CG period, wherein the number of consecutive slots is determined based on the first parameter.

### CROSS-REFERENCE TO RELATED APPLICATION(S)

The present disclosure claims the benefit of and priority to U.S. Provisional Patent Application Ser. No. 63/397,555, filed on Aug. 12, 2022, entitled “METHOD AND APPARATUS TO CONFIGURE ADDITIONAL CG PUSCH OCCASIONS FOR A CG CONFIGURATION,” the content of which is hereby incorporated herein fully by reference into the present disclosure for all purposes.

### FIELD

The present disclosure generally relates to wireless communications and, more particularly, to methods for allocation of multi-Physical Uplink Shared Channel (PUSCH) configured grants and devices using this method.

### BACKGROUND

With the tremendous growth in the number of connected devices and the rapid increase in user/network (NW) traffic volume, various efforts have been made to improve different aspects of wireless communication for next-generation wireless communication systems, such as fifth-generation (5G) New Radio (NR), by improving data rate, latency, reliability, and mobility.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation wireless communication systems.

### SUMMARY

The present disclosure is directed to methods for allocation of multi-Physical Uplink Shared Channel (PUSCH) configured grants and devices using this method.

According to a first aspect of the present disclosure, a method performed by a User Equipment (UE) for allowing more than one Physical Uplink Shared CHannels (PUSCHs) in each of a plurality of Configured Grant (CG) periods is provided. The method includes receiving, from a Base Station (BS), a CG configuration for configuring the plurality of CG periods; receiving, from the BS, a Radio Resource Control (RRC) configuration including a first parameter; and determining, for each of the plurality of CG periods, that a CG PUSCH occasion exists in each of a number of consecutive slots within the corresponding CG period, wherein the number of consecutive slots is determined based on the first parameter.

In some implementations of the first aspect of the present disclosure, the method further includes receiving, from the BS, Downlink Control Information (DCI) for activating the CG configuration, the DCI indicating a Start and Length Indicator Value (SLIV) included in a Time Domain Resource Assignment (TDRA) field; and applying the SLIV to each CG PUSCH occasion.

In some implementations of the first aspect of the present disclosure, the method further includes determining a Hybrid Automatic Repeat reQuest (HARQ) process IDentifier (ID) of a second CG PUSCH occasion within one of the plurality of CG periods by incrementing a HARQ process ID of a first CG PUSCH occasion by one. The first CG PUSCH is within the one of the plurality of CG periods and is before the second CG PUSCH occasion by one.

In some implementations of the first aspect of the present disclosure, the method further includes: receiving, from the BS, a Time Division Duplexing (TDD) configuration; and determining, in a case that a certain CG PUSCH occasion within one of the plurality of CG periods overlaps with at least one downlink (DL) symbol indicated by the TDD configuration, that the certain CG PUSCH occasion is invalid.

In some implementations of the first aspect of the present disclosure, the first parameter is in a form of an integer.

In some implementations of the first aspect of the present disclosure, the method further includes receiving, from the BS, a second parameter indicating a number of repetitions of a PUSCH occasion that is not associated with the CG configuration; and determining, in a case that one of the number of repetitions of the PUSCH occasion overlaps with the CG PUSCH occasion corresponding to the CG configuration, that the one of the number of repetitions of the PUSCH occasion is invalid.

In some implementations of the first aspect of the present disclosure, the method further includes receiving, from the BS, a third parameter indicating a number of repetitions of the CG PUSCH occasion corresponding to the CG configuration; and determining, in a case that a first CG PUSCH occasion corresponding to the CG configuration overlaps with one of a number of repetitions of a second CG PUSCH occasion corresponding to the CG configuration, that the one of the number of repetitions of the second CG PUSCH occasion is invalid.

In some implementations of the first aspect of the present disclosure, in a case that a CG PUSCH occasion within the one of the plurality of CG periods is invalid, omitting the invalid CG PUSCH occasion and determining not to perform a PUSCH transmission in the invalid CG PUSCH occasion.

According to a second aspect of the present disclosure, a User Equipment (UE) for allowing more than one Physical Uplink Shared CHannels (PUSCHs) in each of a plurality of Configured Grant (CG) periods is provided. The UE includes one or more processors and at least one memory coupled to at least one of the one or more processors. The at least one memory stores one or more computer-executable instructions that, when executed by the at least one of the one or more processors, cause the UE to receive, from a Base Station (BS), a CG configuration for configuring the plurality of CG periods; receive, from the BS, a Radio Resource Control (RRC) configuration including a first parameter; and determine, for each of the plurality of CG periods, that a CG PUSCH occasion exists in each of a number of consecutive slots within the corresponding CG period, wherein the number of consecutive slots is determined based on the first parameter.

In some implementations of the second aspect of the present disclosure, the one or more computer-executable instructions, when executed by the at least one of the one or more processors, further cause the UE to receive, from the BS, Downlink Control Information (DCI) for activating the CG configuration, the DCI indicating a Start and Length Indicator Value (SLIV) included in a Time Domain Resource Assignment (TDRA) field; and apply the SLIV to each CG PUSCH occasion.

In some implementations of the second aspect of the present disclosure, the one or more computer-executable instructions, when executed by the at least one of the one or more processors, further cause the UE to determine a Hybrid Automatic Repeat reQuest (HARQ) process IDentifier (ID) of a second CG PUSCH occasion within one of the plurality of CG periods by incrementing a HARQ process ID of a first CG PUSCH occasion by one. The first CG PUSCH is within the one of the plurality of CG periods and is before the second CG PUSCH occasion.

In some implementations of the second aspect of the present disclosure, the one or more computer-executable instructions, when executed by the at least one of the one or more processors, further cause the UE to receive, from the BS, a Time Division Duplexing (TDD) configuration; and determine, in a case that a certain CG PUSCH occasion within one of the plurality of CG periods overlaps with at least one DL symbol indicated by the TDD configuration, that the certain CG PUSCH occasion is invalid.

In some implementations of the second aspect of the present disclosure, the first parameter is in a form of an integer.

In some implementations of the second aspect of the present disclosure, the one or more computer-executable instructions, when executed by the at least one of the one or more processors, further cause the UE to receive, from the BS, a second parameter indicating a number of repetitions of a PUSCH occasion that is not associated with the CG configuration; and determine, in a case that one of the number of repetitions of the PUSCH occasion overlaps with the CG PUSCH occasion corresponding to the CG configuration, that the one of the number of repetitions of the PUSCH occasion is invalid.

In some implementations of the second aspect of the present disclosure, the one or more computer-executable instructions, when executed by the at least one of the one or more processors, further cause the UE to receive, from the BS, a third parameter indicating a number of repetitions of the CG PUSCH occasion corresponding to the CG configuration; and determine, in a case that a first CG PUSCH occasion corresponding to the CG configuration overlaps with one of a number of repetitions of a second CG PUSCH occasion corresponding to the CG configuration, that the one of the number of repetitions of the second CG PUSCH occasion is invalid.

In some implementations of the second aspect of the present disclosure, the one or more computer-executable instructions, when executed by the at least one of the one or more processors, further cause the UE to, in a case that a CG PUSCH occasion within the one of the plurality of CG periods is invalid, omit the invalid CG PUSCH occasion and determine not to perform a PUSCH transmission in the invalid CG PUSCH occasion.

According to a third aspect of the present disclosure, a Base Station (BS) for allowing more than one Physical Uplink Shared CHannels (PUSCHs) in each of a plurality of Configured Grant (CG) periods is provided. The BS includes one or more processors and at least one memory coupled to at least one of the one or more processors. The at least one memory stores one or more computer-executable instructions that, when executed by the at least one of the one or more processor, cause the BS to transmit, to a User Equipment (UE), a CG configuration for configuring the plurality of CG periods; and transmit, to the UE, a Radio Resource Control (RRC) configuration including a first parameter. The first parameter indicates a number of consecutive slots, such that for each of the plurality of CG periods, a CG PUSCH occasion exists in each of the number of consecutive slots within the corresponding CG period.

In some implementations of the third aspect of the present disclosure, the one or more computer-executable instructions, when executed by the at least one of the one or more processors, further cause the BS to transmit, to the UE, Downlink Control Information (DCI) for activating the CG configuration, the DCI indicating a Start and Length Indicator Value (SLIV) included in a Time Domain Resource Assignment (TDRA) field.

In some implementations of the third aspect of the present disclosure, the one or more computer-executable instructions, when executed by the at least one of the one or more processors, further cause the BS to determine a Hybrid Automatic Repeat reQuest (HARQ) process IDentifier (ID) of a second CG PUSCH occasion within one of the plurality of CG periods by incrementing a HARQ process ID of a first CG PUSCH occasion by one. The first CG PUSCH is within the one of the plurality of CG periods and is before the second CG PUSCH occasion.

In some implementations of the third aspect of the present disclosure, the one or more computer-executable instructions, when executed by the at least one of the one or more processors, further cause the BS to transmit, to the UE, a Time Division Duplexing (TDD) configuration; and determine, in a case that a certain CG PUSCH occasion within one of the plurality of CG periods overlaps with at least one DL symbol indicated by the TDD configuration, not to receive the certain CG PUSCH occasion.

In some implementations of the third aspect of the present disclosure, the first parameter is in a form of an integer.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a diagram illustrating a jitter issue in a configured grant (CG) configuration with fixed periodicity, according to an example implementation of the present disclosure.

FIG. 2 is a diagram illustrating additional CG physical uplink shared channel (PUSCH) occasion(s) to counteract jitter, according to an example implementation of the present disclosure.

FIG. 3 is a diagram illustrating overlapping between CG PUSCH occasions and CG PUSCH repetitions, according to an example implementation of the present disclosure.

FIG. 4 is a diagram illustrating overlapping between CG PUSCH occasions and CG PUSCH repetitions, according to an example implementation of the present disclosure.

FIG. 5 is a diagram illustrating transmitting more than one transport blocks (TB s) within a CG PUSCH occasion bundle, according to an example implementation of the present disclosure.

FIG. 6 is a diagram illustrating transmitting more than one TB s within a CG PUSCH occasion bundle, according to an example implementation of the present disclosure.

FIG. 7 is a flowchart of a method for allowing more than one PUSCHs in each of a plurality of CG periods, according to an example implementation of the present disclosure.

FIG. 8 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “In some implementations,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuitries (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BS s.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access NW. The BS supports the operations of the cells. Each cell is operable to provide services to at least one UE within its radio coverage. For example, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” herein may be used interchangeably. The term “and/or” herein is only an association relationship for describing associated objects, and represents that three relationships may exist. For example, A and/or B may indicate that A exists alone, A and B exist at the same time, or B exists alone. In addition, the character “I” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

Some of the terms, definitions, and abbreviations as given in this document are either imported from existing documentation (European Telecommunications Standards Institute (ETSI), International Telecommunication Union (ITU), or elsewhere) or newly created by 3GPP experts whenever the need for precise vocabulary is identified.

In Release 17 (e.g., 3GPP TR 38.838 v17.0.0) Study Item “Study on XR Evaluations for NR”, Extended Reality (XR) (e.g., Augmented Reality (AR), Mixed Reality (MR) and Virtual Reality (VR)) and Cloud Gaming are determined to be currently the most important 5G media applications under consideration in the industry.

Specifically, XR is an umbrella term for multiple heterogeneous use cases and services that have been studied in Service and System Aspects Working Group 1 (SA1), SA2 and SA4. The outcome of the studies includes, but is not limit to, Technical Report (TR) 22.842, TR 26.928 and TR 26.998. These XR cases may be roughly divided into mainly three categories of AR, VR, and MR.

In addition, Cloud Gaming pertains to scenarios where the vast majority of computations related to gaming are offloaded from the UE to edge or remote servers, or, conversely, from the edge or remote servers to the UE.

Regardless of whether the context is (XR) or Cloud Gaming, the system throughput must be exceedingly high, and the round-trip delay (e.g., delay in data transmission due to propagation from the UE to the BS and back) must be exceedingly short. Failing to meet these criteria could potentially result in XR users, or game players in Cloud Gaming scenarios, experiencing discomfort or even more serious side effects such as dizziness.

According to 3GPP TR 38.838 V17.0.0 “Study on XR Evaluations for NR”, the packet arrival rate of a single-stream model (e.g., including multi-stream model with one or two stream as a video stream) in AR uplink (UL) traffic may be determined by the frame generation rate (e.g., 60 frames per second (fps)). However, in a real system, the varying frame encoding delay may produce jitter in the packet arrival time at the UE. The jitter is modeled as a random variable superimposed on periodic arrivals. The jitter follows truncated Gaussian distribution with statistical parameters, as outlined below in Table 1.

TABLE 1
Parameters of DL XR Traffic

| | | Baseline value | Optional value |
|---|---|---|---|
| Parameter | Unit | for evaluation | for evaluation |
| Mean | ms | 0 | |
| STD | ms | 2 | |
| Truncation range | ms | [−4, 4] | [−5, 5] |

Due to the jitter, the packet arrival time may not be strictly periodic, but quasi-periodic. In the current Release-17 NR specifications, once a Configured Grant (CG) configuration is set by the Radio Resource Control (RRC) layer, the periodicity may not be altered until an RRC reconfiguration occurs. This is not compatible with the “quasi-periodic” packet arrival time in the AR UL traffic.

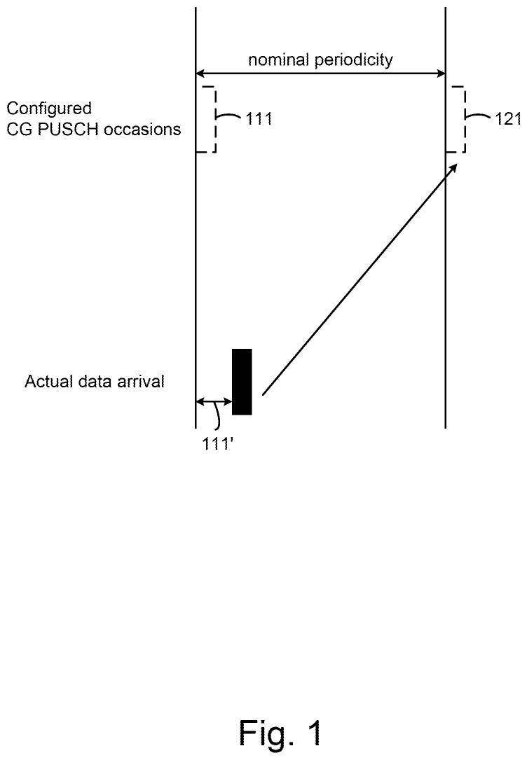

FIG. 1 is a diagram illustrating a jitter issue in a configured grant (CG) configuration with fixed periodicity, according to an example implementation of the present disclosure.

As shown in FIG. 1, the late data arrival 111′ makes it impossible for the UE to transmit the data in the configured CG Physical Uplink Shared Channel (PUSCH) occasion 111. Therefore, the UE has no other choice but to transmit the data in the next configured CG PUSCH occasion 121 or to rely on dynamic scheduling. This may result in the latency of the traffic exceeding the packet delay budget (PDB) and thus the Quality of Service (QoS) may not be met.

In the downlink, the gNB may dynamically allocate resources to the UEs via the Cell-Radio Network Temporary Identifier (C-RNTI) on physical downlink control channel(s) (PDCCH(s)). A UE may constantly monitor the PDCCH(s) to find potential assignments when its downlink reception is enabled (e.g., an activity controlled by discontinuous reception (DRX) when configured). When carrier aggregation (CA) is configured, the same C-RNTI may be applied to all serving cells.

With Semi-Persistent Scheduling (SPS), the gNB may allocate downlink resources, for example, for the initial Hybrid Automatic Repeat Request (HARQ) transmissions, to the UEs (e.g., via DL-specific RRC signaling). The RRC (signaling) may define the periodicity of the configured downlink assignments while the PDCCH addressed to the Cell-Specific Radio Network Temporary Identifier (CS-RNTI) may either signal and activate the configured downlink assignment, or deactivate it. That is, a PDCCH addressed to the CS-RNTI may indicate that the downlink assignment may be implicitly reused according to the periodicity defined by the RRC signaling, until it is deactivated.

When necessary, retransmissions may be explicitly scheduled on the PDCCH(s).

The dynamically allocated downlink reception may override the configured downlink assignment in the same serving cell if they overlap in time. Otherwise, if activated, a downlink reception according to the configured downlink assignment may be presumed.

The UE may be configured with up to 8 active configured downlink assignments for a given bandwidth part (BWP) of a serving cell. In a case that more than one active configured downlink assignment is configured:
the network may decide which of the configured downlink assignments are active at a time (e.g., including all of them); and
each configured downlink assignment may be activated/deactivated separately using a DCI command, where the DCI command may either deactivate a single configured downlink assignment or multiple configured downlink assignments jointly.

With Configured Grants, the gNB may allocate, to the UEs, uplink resources for the initial HARQ transmissions and HARQ retransmissions. Two types of configured uplink grants may be defined: Type 1 and Type 2.

With Type 1, the RRC layer may directly provide the configured uplink grant (e.g., including the periodicity).

With Type 2, the RRC layer may define the periodicity of the configured uplink grant while the PDCCH addressed to CS-RNTI may either signal and activate the configured uplink grant, or deactivate it. That is, a PDCCH addressed to the CS-RNTI may indicate that the uplink grant may be implicitly reused, according to the periodicity defined by the RRC, until it is deactivated.

For a PUSCH repetition Type B, the UE may determine invalid symbol(s) for a PUSCH repetition Type B transmission according to at least one of the following:
A symbol that is indicated as downlink by tdd-UL-DL-ConfigurationCommon or tdd-UL-DL-ConfigurationDedicated may be considered as an invalid symbol for a PUSCH repetition Type B transmission.
For operation in unpaired spectrum, symbols indicated by ssb-PositionsInBurst in System Information Block Type 1 (SIB1) or ssb-PositionsInBurst in ServingCellConfigCommon for reception of the Synchronized Signal (SS)/Physical Broadcast Channel (PBCH) blocks may be considered as invalid symbols for a PUSCH repetition Type B transmission.
For a reduced capability half-duplex UE in paired spectrum and for a PUSCH repetition Type B transmission, symbols indicated by ssb-PositionsInBurst in SIB1 or ssb-PositionsInBurst in ServingCellConfigCommon for the reception of SS/PBCH blocks may be considered as invalid symbols for a PUSCH repetition Type B transmission.
For an operation in an unpaired spectrum, symbol(s) indicated by pdcch-ConfigSIB1 in a Master Information Block (MIB) for a control resource set (CORESET) for Type0-PDCCH common search space (CSS) set may be considered as invalid symbol(s) for a PUSCH repetition Type B transmission.
For an operation in an unpaired spectrum, if numberOfInvalidSymbolsForDL-UL-Switching is configured, numberOfInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated may be considered as invalid symbol(s) for the PUSCH repetition Type B transmission. The symbol(s) given by numberOfInvalidSymbolsForDL-UL-Switching may be defined using the reference sub-carrier space (SCS) configuration referenceSubcarrierSpacing provided in tdd-UL-DL-ConfigurationCommon.
For an operation with a shared spectrum channel access with semi-static channel occupancy, symbols in an idle duration associated with a periodic channel occupancy (e.g., as described in Clause 4.3.1.1 of 3GPP TS 37.213 Release 17), or in an idle duration in a period associated with an initiated channel occupancy (e.g., as described in Clause 4.3.2. of 3GPP TS 37.213 Release 17) may be considered as invalid symbol(s) for a PUSCH repetition Type B transmission.
A UE may be configured with the higher layer parameter invalidSymbolPattern, which may provide a symbol level bitmap spanning one or two slots. A bit value equal to 1 in the symbol level bitmap symbols indicates that the corresponding symbol is an invalid symbol for a PUSCH repetition Type B transmission. The UE may be additionally configured with a time-domain pattern (e.g., a higher layer parameter periodicityAndPattern given by invalidSymbolPattern), where each bit of the periodicityAndPattern may correspond to a unit equal to a duration of the symbol level bitmap symbols, and a bit value equal to 1 indicates that the symbol level bitmap symbols is present in the unit. The periodicityAndPattern may be {1, 2, 4, 5, 8, 10, 20 or 40} units long, but a maximum of 40 msec. The first symbol of periodicityAndPattern every 40 msec/P periods is a first symbol in frame n_{f}, where n_{f} mod 4=0, where P is the duration of periodicityAndPattern-r16 in units of msec. When periodicityAndPattern is not configured, for a symbol level bitmap spanning two slots, the bits of the first and second slots may correspond respectively to even and odd slots of a radio frame; and for a symbol level bitmap spanning one slot, the bits of the slot may correspond to every slot of a radio frame.

If invalidSymbolPattern is configured, the condition under which the UE applies the invalid symbol pattern may be determined as follows:
if the PUSCH is scheduled by DCI format 0_1, or corresponds to a Type 2 configured grant activated by DCI format 0_1, and if invalidSymbolPatternIndicatorDCI-0-1 is configured,
   if invalid symbol pattern indicator field is set to 1, the UE applies the invalid symbol pattern;
   otherwise, the UE does not apply the invalid symbol pattern;
if the PUSCH is scheduled by DCI format 0_2, or corresponds to a Type 2 configured grant activated by DCI format 0_2, and if invalidSymbolPatternIndicatorDCI-0-2 is configured,
   if invalid symbol pattern indicator field is set to 1, the UE applies the invalid symbol pattern;
   otherwise, the UE does not apply the invalid symbol pattern;
otherwise, the UE applies the invalid symbol pattern.
If the UE
   is configured with multiple serving cells within a cell group and is provided with directionalCollisionHandling-r16=‘enabled’ for a set of serving cell(s) among the multiple serving cells, and
   indicates support of half-DuplexTDD-CA-SameSCS-r16 capability, and
   is not configured to monitor PDCCH for detection of DCI format 2-0 on any of the multiple serving cells,
      a symbol indicated to the UE for reception of SS/PBCH blocks in a first cell of the multiple serving cells by ssb-PositionsInBurst in SIB1 or ssb-PositionsInBurst in ServingCellConfigCommon is considered as an invalid symbol for PUSCH repetition Type B transmission in
         any of the multiple serving cells if the UE is not capable of simultaneous transmission and reception as indicated by simultaneousRxTxInterBandCA among the multiple serving cells, and
         any one of the cells corresponding to the same band as the first cell, irrespective of any capability indicated by simultaneousRxTxInterBandCA and
      a symbol is considered as an invalid symbol in another cell among the set of serving cell(s) provided with directionalCollisionHandling-r16 for PUSCH repetition Type B transmission with Type 1 or Type 2 configured grant except for the first Type 2 PUSCH transmission (including all repetitions) after activation if the symbol is indicated as downlink by tdd-UL-DL-ConfigurationCommon or tdd-UL-DL-ConfigurationDedicated on the reference cell (e.g., as defined in Clause 11.1 of 3GPP TS 38.213 Release 17), or the UE is configured (e.g., by the higher layers) to receive the PDCCH, PDSCH, or CSI-RS on the reference cell in the symbol.

After determining the invalid symbol(s) for a PUSCH repetition Type B transmission for each of the K nominal repetitions, the remaining symbols are considered as potentially valid symbols for a PUSCH repetition Type B transmission. If the number of potentially valid symbols for the PUSCH repetition type B transmission is greater than zero for a nominal repetition, the nominal repetition includes one or more actual repetitions, where each actual repetition includes a consecutive set of all potentially valid symbols that may be used for the PUSCH repetition Type B transmission within a slot. An actual repetition with a single symbol is omitted except in a case that the scheduled number of symbols is 1 (e.g., L=1 indicated by the SLIV value). An actual repetition may be omitted according to, for example, the conditions described in Clause 9, Clause 11.1, Clause 11.2A and Clause 17.2 of 3GPP TS 38.213 Release 17. The UE may repeat the transport block (TB) across actual repetitions. The redundancy version to be applied on the n^{th} actual repetition (e.g., with the counting including the actual repetitions that are omitted) is determined according to table 6.1.2.1-2 in 3GPP TS 38.214 V17.2.0, where the number of slots used for transport block size (TBS) determination is 1 (e.g., N=1).

The following procedures describing a PUSCH Repetition Type A with a configured grant may be applied to a PUSCH transmissions of PUSCH repetition Type A with a Type 1 or Type 2 configured grant.

The higher layer parameter repK-RV defines the redundancy version pattern to be applied to the repetitions. If cg-RetransmissionTimer is provided, the redundancy version for an uplink transmission with a configured grant may be determined by the UE. If the parameter repK-RV is not provided in the configuredGrantConfig and cg-Retransmission Timer is not provided, the redundancy version for the uplink transmissions with a configured grant may be set to 0. If the parameter repK-RV is provided in the configuredGrantConfig and cg-RetransmissionTimer is not provided, for the n^{th} transmission occasion among K repetitions, n=1, 2, . . . , K, it may be associated with (mod((n-mod(n, N))/N, 4)+1)^{th} value in the configured RV sequence, where N=1. If a configured grant configuration is configured with startingFromRV0 set to ‘off’, the initial transmission of a transport block may only start at the first transmission occasion of the K repetitions. Otherwise, the initial transmission of a transport block may start at:
the first transmission occasion of the K repetitions if the configured RV sequence is {0, 2, 3, 1},
any of the transmission occasions of the K repetitions that are associated with RV=0 if the configured RV sequence is {0, 3, 0, 3}, or
any of the transmission occasions of the K repetitions if the configured RV sequence is {0, 0, 0, 0}, except the last transmission occasion when K≥8.

When the transmission occasions are associated with the first and second Sounding Reference Signal (SRS) resource sets, if the parameter repK-RV is provided in the configuredGrantConfig, for the n^{th} transmission occasion among all transmission occasions that are associated with the SRS resource set of the first transmission occasion, it may be associated with (mod(n−1, 4)+1)^{th} value in the configured RV sequence; and for the n^{th} transmission occasion among all transmission occasions that are not associated with the SRS resource set of the first transmission occasion, it may be associated with (mod(n−1, 4)+1)^{th} value in the adjusted RV sequence and the adjustment is based on additional shifting operation on the configured RV sequence, where the shifting operation is defined as (rvᵢ+rvₛ)mod 4, where rvᵢ is the i^{th} RV value (i=1, 2, 3, 4) in the configured RV sequence and rvₛ is configured by the higher layer parameter sequenceOffsetforRV in configuredGrantConfig.

When the transmission occasions are associated with the first and second SRS resource sets, if a configured grant configuration is configured with startingFromRV0 set to ‘off’, the initial transmission of a transport block may only start at the first transmission occasion of the K repetitions. Otherwise, the initial transmission of a transport block may start at
the first transmission occasion associated with RV=0 corresponding to the first or second SRS resource sets of the K repetitions if the configured RV sequence is {0, 2, 3, 1},
any of the transmission occasions of the K repetitions that are associated with RV=0 if the configured RV sequence is {0, 3, 0, 3}, or
any of the transmission occasions of the K repetitions if the configured RV sequence is {0, 0, 0, 0}, except the last transmission occasion when K≥8.

After the initial transmission of a transport block, later transmission occasions among the K repetitions associated with any RV value and associated with any of the first or second SRS resource sets may be used for transmitting the transport block.

For any RV sequence, the repetitions may be terminated after transmitting K repetitions, or at the last transmission occasion among the K repetitions within the period P, or from the starting symbol of the repetition that overlaps with a PUSCH with the same HARQ process scheduled by DCI format 0_0, 0_1 or 0_2, whichever is reached first. In addition, the UE may terminate the repetition of a transport block in a PUSCH transmission if the UE receives a DCI format 0_1 with DFI flag provided and set to “1”, and if in this DCI the UE detects ACK for the HARQ process corresponding to that transport block.

The UE is not expected to be configured with a time duration for the transmission of K repetitions larger than the time duration derived by the periodicity P. If the UE determines that, for a transmission occasion, the number of symbols available for the PUSCH transmission in a slot is smaller than a transmission duration L, the UE may not transmit the PUSCH in the transmission occasion.

For both Type 1 and Type 2 PUSCH transmissions with a configured grant, when K>1,
For unpaired spectrum:
   If AvailableSlotCounting is enabled, the UE may repeat the TB across the N K slots determined for the PUSCH transmission applying the same symbol allocation in each slot.
      A slot is not counted in the number of N·K slots if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst.
   Otherwise, the UE may repeat the TB across the N·K consecutive slots, applying the same symbol allocation in each slot, except if the UE is provided with higher layer parameters cg-nrofSlots and cg-nrofPUSCH-InSlot, in such case the UE repeats the TB in the repK earliest consecutive transmission occasion candidates within the same configuration.
For paired spectrum and SUL band:
   The UE may repeat the TB across the N·K consecutive slots, applying the same symbol allocation in each slot, except if the UE is provided with higher layer parameters cg-nrofSlots and cg-nrofPUSCH-InSlot, in such case the UE repeats the TB in the repK earliest consecutive transmission occasion candidates within the same configuration.
   If AvailableSlotCounting is enabled, and in case of reduced capability half-duplex UE, the UE may repeat the TB across the N·K slots, applying the same symbol allocation in each slot. A slot is not counted in the number of N·K slots if at least one of the symbols indicated by the indexed row of the used resource allocation table in the slot overlaps with or a symbol of an SS/PBCH block with index provided by ssb-PositionsInBurst.

A Type 1 or Type 2 PUSCH transmission with a configured grant in a slot may be omitted according to, for example, the conditions in Clause 9, Clause 11.1, Clause 11.2A and Clause 17.2 of 3GPP TS 38.213 Release 17.

The following procedures describing the PUSCH Repetition Type B with a configured grant may be applied to a PUSCH transmissions of PUSCH repetition type B with a Type 1 or Type 2 configured grant.

For a PUSCH transmissions with a Type 1 or Type 2 configured grant, the nominal repetitions and the actual repetitions are determined according to the procedures for the PUSCH repetition Type B defined in Clause 6.1.2.1 (e.g., of 3GPP TS 38.213 Release 17). The higher layer configured parameters repK-RV define the redundancy version pattern that is to be applied to the repetitions. If the parameter repK-RV is not provided in the configuredGrantConfig, the redundancy version for each actual repetition with a configured grant may be set to 0. Otherwise, for the n^{th} transmission occasion among all the actual repetitions (including the actual repetitions that are omitted) of the K nominal repetitions, it is associated with (mod((n-mod(n, N))/N, 4)+1)^{th} value in the configured RV sequence, where N=1. If a configured grant configuration is configured with startingFromRV0 set to “off”, the initial transmission of a transport block may only start at the first transmission occasion of the actual repetitions. Otherwise, the initial transmission of a transport block may start at:
the first transmission occasion of the actual repetitions if the configured RV sequence is {0, 2, 3, 1},
any of the transmission occasions of the actual repetitions that are associated with RV=0 if the configured RV sequence is {0, 3, 0, 3}, or
any of the transmission occasions of the actual repetitions if the configured RV sequence is {0, 0, 0, 0}, except the actual repetitions within the last nominal repetition when K≥8.

When the transmission occasions are associated with the first and second SRS resource sets, if the parameter repK-RV is provided in the configuredGrantConfig:
for the n^{th} transmission occasion among all actual repetitions (including the actual repetitions that are omitted) that are associated with the SRS resource set of the first transmission occasion, it may be associated with (mod(n−1, 4)+1)^{th} value in the configured RV sequence; and
for the n^{th} transmission occasion among all actual repetitions that are not associated with the SRS resource set of the first transmission occasion, it may be associated with (mod(n−1, 4)+1)^{th} value in the adjusted RV sequence and the adjustment may be based on additional shifting operation on the configured RV sequence.

The shifting operation is defined as (rvᵢ+rvₛ)mod 4, where rvᵢ is the i^{th} RV value (i=1, 2, 3, 4) in the configured RV sequence, and rvₛ is configured by the higher layer parameter sequenceOffsetforRV in configuredGrantConfig.

When the transmission occasions are associated with the first and second SRS resource sets, if a configured grant configuration is configured with startingFromRV0 set to “off”, the initial transmission of a transport block may start at the first transmission occasion of the K repetitions. Otherwise, the initial transmission of a transport block may start at:
the first transmission occasion associated with RV=0 corresponding to the first or second SRS resource sets of the K repetitions if the configured RV sequence is {0, 2, 3, 1},
any of the transmission occasions of the K repetitions that are associated with RV=0 if the configured RV sequence is {0, 3, 0, 3}, or
any of the transmission occasions of the K repetitions if the configured RV sequence is {0, 0, 0, 0} except the last transmission occasion when K≥8.

After the initial transmission of a transport block, later transmission occasions among the K repetitions associated with any RV value and associated with any of the first or second SRS resource sets may be used for transmitting the transport block.

For any RV sequence, the repetitions may be terminated after transmitting K nominal repetitions, or at the last transmission occasion among the K nominal repetitions within the period P, or from the starting symbol of an actual repetition that overlaps with a PUSCH with the same HARQ process scheduled by DCI format 0_0, 0_1 or 0_2, whichever is reached first. The UE is not expected to be configured with the time duration for the transmission of K nominal repetitions larger than the time duration derived by the periodicity P.

Since the gNB/NW may obtain some information (e.g., traffic arrival interval/periodicity) of the XR (e.g., AR) UL traffic from the higher layers (or UEs), the gNB/NW may configure one or more additional transmission occasions (TOs) for an XR UE to transmit the CG PUSCHs, such that the additional TOs cover the potential maximum jitter offset.

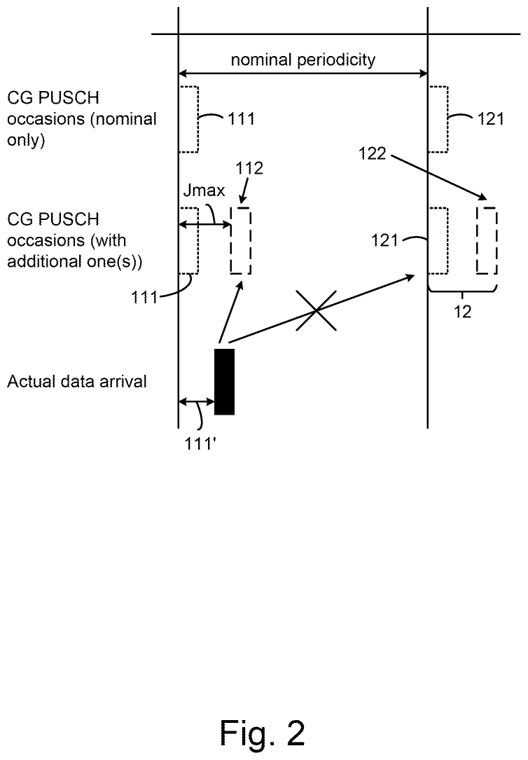

FIG. 2 is a diagram illustrating additional CG PUSCH occasion(s) to counteract jitter, according to an example implementation of the present disclosure.

As shown in FIG. 2, one additional CG PUSCH occasion 112, 122 is configured after the CG PUSCH occasion 111, 121 within each periodicity to cover the potential maximum jitter offset Jmax. If there is a late data arrival 111′ caused by the jitter, the UE may not have to delay the transmission of the data to the next CG PUSCH occasion 121 (e.g., the next CG PUSCH occasion that occurs after the current CG periodicity). Instead, the UE may transmit the data in the additionally configured CG PUSCH occasion 112, and this may reduce the latency when using CG to deliver the XR (e.g., AR) UL traffic.

It should be noted that in the present disclosure, the term “CG PUSCH occasion bundle (e.g., 12)” is introduced and it is formed by the nominal CG PUSCH occasion (e.g., 121) and the additional CG PUSCH occasion(s) (e.g., 122) within a (nominal) periodicity.

In the disclosure, the term “CG PUSCH” may refer to PUSCH(s) scheduled by DCI in PDCCH with CRC scrambled CS-RNTI with NDI=0, and/or PUSCH scheduled without corresponding PDCCH transmission using configuredGrantConfig/ConfiguredGrantConfig, configuredGrantConfigToAddModList (and activated by DCI).

In this disclosure, there are some terminologies related to CG PUSCH occasions: “nominal CG PUSCH occasion”, “additional CG PUSCH occasion” and “CG PUSCH occasion bundle”. Their definitions are given as follows:

Nominal CG PUSCH occasion: the CG PUSCH transmission occasion described in 3GPP TS 38.214 Release 17 V17.2.0. Specifically, the nominal CG PUSCH occasion is the CG PUSCH occasion allocated by gNB/NW for initial HARQ transmissions and HARQ retransmissions and configured by a CG configuration. For example, the nominal CG PUSCH occasions may be the n^{th} (e.g., the first) CG PUSCH occasion (e.g., 111, 121 of FIG. 2) within each periodicity. For example, the nominal CG PUSCH occasions may be the last CG PUSCH occasion within each periodicity.

Additional CG PUSCH occasion(s): the CG PUSCH transmission occasion(s) (e.g., 112, 122 of FIG. 2) that is configured (e.g., via the method introduced in the present disclosure) other than the nominal CG PUSCH occasion (e.g., 111, 121 of FIG. 2).

CG PUSCH occasion bundle: formed by a nominal CG PUSCH occasion (e.g., 111 or 121 of FIG. 2) and a number of consecutive additional CG PUSCH occasions (e.g., 112 or 122 of FIG. 2). Alternatively, formed by a nominal CG PUSCH occasion and one or some additional CG PUSCH occasions.

It should be note that the term “a CG PUSCH” in the present disclosure may be replaced by:
“a/one PUSCH (on a serving cell each) (scheduled) without a corresponding PDCCH transmission”, or “a/one PUSCH scheduled by the DCI in a PDCCH with CRC scrambled by CS-RNTI with NDI=0”, where the DCI may be DCI format 0_0, DCI format 0_1, DCI format 0_2, and/or a new DCI format.

In some implementations, for a Type 1 or Type 2 CG configuration for a UE, multiple CG PUSCH occasions may be provisioned within a given period. The CG PUSCH occasions within a period may form a CG PUSCH occasion bundle.

In some implementations, the period may be given by a periodicity of the CG configuration.

In some implementations, the period may be configured as a specific configuration for the mechanism of Multiple CG PUSCH occasions within a CG PUSCH occasion Bundle.

In some examples, the unit of the period may be a number of the “periodicity of the CG configuration”.

In some examples, the unit of the period may be a symbol, slot, subframe, system frame, millisecond (ms), or a second.

In some implementations, the UE may determine the multiple CG PUSCH occasions within a period based on a configured offset (e.g., which may be provided by an RRC parameter) or a list of offsets (e.g., which may be provided by an RRC parameter).

In some implementations, the UE may determine the multiple CG PUSCH occasions within a period based on a row of the TDRA table that the UE is indicated (e.g., by the “Time domain resource assignment” field included in the DCI that activates this CG configuration) if the row of the TDRA table contains multiple entries.

In some implementations, a UE may be provided with a value of the offset and/or a set of values of the offset (e.g., that may be used by the UE to determine the CG PUSCH occasions within a CG PUSCH occasion bundle) by a first RRC parameter, or by a first RRC parameter and indicated by a DCI (e.g., activation/deactivation DCI for Type 2 CG).

In some implementations, if a UE is an XR-specific UE (e.g., the UE has XR capability), the UE may be provided with the first RRC parameter.

In some implementations, if a UE transmits specific information to the NW/gNB, the UE may be provided with the first RRC parameter.

For example, the specific information may be transmitted via an assistance information/UEAssistanceInformation IE (e.g., the assistance information for XR, for non-integer DRX cycle, and/or for DRX preference).

For example, the specific information may be transmitted via a UE capability information/UECapabilityInformation IE (e.g., the UE capability information for XR, for non-integer DRX cycle, and/or for DRX preference).

For example, the specific information may indicate the information for the XR traffic pattern/XR application/frame per second/periodicity for DRX/pose control information.

For example, the specific information may be transmitted via a Medium Access Control Control Element (MAC CE) (e.g., a Scheduling Request (SR), a Buffer Status Report (BSR), and/or a XR MAC CE).

In some implementations, if a UE is performing a procedure for XR, the UE may be provided with the first RRC parameter.

In some implementations, if a UE receives a specific indication, from the BS, the UE may be provided with the first RRC parameter.

In some implementations, if a UE is configured with a specific configuration/IE, by the NW/gNB, the UE may be provided with the first RRC parameter.

For example, the specific configuration may indicate a scheduling information for XR traffic.

For example, the specific configuration may trigger an XR procedure.

In some implementations, when the UE is configured with the first RRC parameter, the UE may determine whether to apply the first RRC parameter based on an indication. The indication may be, for example, a RRC parameter/IE and/or a DCI (e.g., to indicate enable/disable).

If the indication indicates a first value, the UE may apply the first RRC parameter.

If the indication indicates a second value different from the first value, the UE may not apply the first RRC parameter.

In some implementations, the first RRC parameter may be a number.

In some implementations, the number may represent the jitter offset or the potential maximum jitter offset.

In some examples, the first RRC parameter may be an integer.

In some examples, the first RRC parameter may be a floating-point number.

In some implementations, the first RRC parameter may be a list of numbers.

In some examples, the first RRC parameter may be a list of integers.

In some examples, the first RRC parameter may be a list of floating-point numbers.

In some examples, the length of the list may be 1, i.e., the first RRC parameter is a list containing one number.

In some implementations, the first RRC parameter may be a list containing lists of numbers.

In some implementations, if the first RRC parameter provides more than one list of a number of integers, there may be a first field in the DCI(s) that the UE is configured to monitor to indicate which entry (list) the UE may use for determining the CG PUSCH occasions.

In some implementations, if the first RRC parameter provides more than one list of a number of integers and the corresponding CG configuration has been activated, the UE may receive a MAC CE/DCI containing information about which entry (list) the UE may use for determining the upcoming CG PUSCH occasions.

In one example, if the gNB/NW configures the first RRC parameter to the UE, the UE may interpret one of the fields in the DCI as the first field. Otherwise, the UE may interpret the DCI based on the existing method.

In some examples, the first RRC parameter may be a list containing lists of numbers.

In some examples, the first RRC parameter may be a list containing lists of floating-point numbers.

In some examples, the length of the first RRC parameter may be 1, i.e., the first RRC parameter is a list containing one list of numbers.

For example, the unit of the value(s) provided by the first RRC parameter may be slot or millisecond (ms) or second or subframe or symbol.

For example, the first RRC parameter may be provided per CG configuration, BWP, (group of) cell, etc. The UE may apply the value of the first RRC parameter in the CG configuration/BWP/(group of) cell where the first RRC parameter is configured.

In some implementations, if a first RRC parameter is provided in a Type 1 or Type 2 CG configuration, the UE may determine the CG PUSCH occasions in addition to the nominal CG PUSCH occasions for the CG configuration according to the first RRC parameter. The UE may transmit the CG PUSCH(s) in one or more CG PUSCH occasions within a CG PUSCH occasion bundle. The CG PUSCH occasion bundle may be determined based on the first RRC parameter, and/or the number of CG PUSCH occasions in a CG PUSCH occasion bundle may be determined based on the first RRC parameter. In some implementations, the UE may consider the New Data Indicator (NDI) bit for a HARQ process of each CG PUSCH occasion within the CG PUSCH occasion bundle as toggled. In other words, each CG PUSCH occasion within the CG PUSCH occasion bundle may be considered as a new UL transmission.

For example, the nominal CG PUSCH occasions may be provided by periodicity in the CG configuration and the TDRA field indicated by the activating DCI that activates the (e.g., most recently) CG configuration and the TDRA table configured by the RRC layer.

In some implementations, the same Start and Length Indicator Value (SLIV) (e.g., provided by the DCI field “Time domain resource assignment” and RRC-configured TDRA table) is applied to all CG PUSCH occasions, including nominal CG PUSCH occasions and additional CG PUSCH occasions, in all CG PUSCH occasion bundles corresponding to the CG configuration.

In some implementations, if the first RRC parameter is a number and the value is denoted by nⱼᵢₜₜₑᵣ, and a nominal CG PUSCH occasion is in slot/subframe n, the UE may determine that an additional CG PUSCH occasion exists at an instance of time which is n jitter slots/milliseconds/subframes/symbols before the nominal CG PUSCH occasion, and/or the UE may determine that an additional CG PUSCH occasion exists at an instance of time which is jitter slots/milliseconds/subframes/symbols after the nominal CG PUSCH occasion.

For example, the first RRC parameter may only be a number larger than or equal to 0.

For example, the first RRC parameter may only be a number larger than 0.

For example, the first RRC parameter may only be a number less than or equal to 0.

For example, the first RRC parameter may only be a number less than 0.

In some implementations, the CG PUSCH occasion bundle may include one nominal CG PUSCH occasion, followed by one additional CG PUSCH occasion after the nominal CG PUSCH occasion.

In some implementations, the CG PUSCH occasion bundle may include one additional CG PUSCH occasion, followed by one nominal CG PUSCH occasion (e.g., as the last CG PUSCH occasion within the CG PUSCH occasion bundle).

For example, if the value provided by the first RRC parameter is 1 and a nominal CG PUSCH occasion occurs at slot/subframe/symbol n, the UE may determine that an additional CG PUSCH occasion exists in slot/subframe/symbol n 1.

For example, if the value provided by the first RRC parameter is 1 and a nominal CG PUSCH occasion occurs at slot/subframe/symbol n, the UE may determine that an additional CG PUSCH occasion exists in slot/subframe/symbol n−1.

For example, if the value provided by the first RRC parameter is 1 and a nominal CG PUSCH occasion occurs in slot/subframe/symbol n, the UE may determine that an additional CG PUSCH occasion exists in slot/subframe/symbol n−1 and slot/subframe/symbol n+1 respectively.

In some implementations, if the first RRC parameter is a number and the value is denoted by nⱼᵢₜₜₑᵣ, and a nominal CG PUSCH occasion is in slot/subframe n, the UE may determine that more than one, e.g., nⱼᵢₜₜₑᵣ−1 or nⱼᵢₜₜₑᵣ, additional CG PUSCH occasions exist between an instance of time which is n jitter slots/milliseconds/subframes/symbols before the nominal CG PUSCH occasion and the nominal CG PUSCH occasion.

In some implementations, if the first RRC parameter is a number and the value is denoted by nⱼᵢₜₜₑᵣ, and a nominal CG PUSCH occasion is in slot/subframe n, the UE may determine that more than one additional CG PUSCH occasions exist between an instance of time which is n jitter slots/milliseconds/subframes/symbols after the nominal CG PUSCH occasion and the nominal CG PUSCH occasion.

For example, the first RRC parameter may only be a number larger than or equal to 0.

For example, the first RRC parameter may only be a number larger than 0.

For example, the first RRC parameter may only be a number less than or equal to 0.

For example, the first RRC parameter may only be a number less than 0.

In some implementations, a CG PUSCH occasion bundle may include one nominal CG PUSCH occasion, followed by nⱼᵢₜₜₑᵣ−1 or jitter additional CG PUSCH occasions after the nominal CG PUSCH occasion.

For example, if the first RRC parameter is 4, and a nominal CG PUSCH occasion occurs in slot/subframe/symbol n, the UE may determine that three additional CG PUSCH occasions exist in slot/subframe/symbol n+1, slot/subframe/symbol n+2 and slot/subframe/symbol n+3, respectively.

For example, if the first RRC parameter is 4, and a nominal CG PUSCH occasion occurs in slot/subframe/symbol n, the UE may determine that four additional CG PUSCH occasions exist in slot/subframe/symbol n+1, slot/subframe/symbol n+2, slot/subframe/symbol n+3 and slot/subframe/symbol n+4, respectively.

In some implementations, a CG PUSCH occasion bundle may include nⱼᵢₜₜₑᵣ−1 or nⱼᵢₜₜₑᵣ CG PUSCH occasions, followed by the nominal CG PUSCH occasion (as the last CG PUSCH occasion within the CG PUSCH occasion bundle).

For example, if the first RRC parameter is 4, and a nominal CG PUSCH occasion occurs in slot/subframe/symbol n, the UE may determine that three additional CG PUSCH occasions exist in slot/subframe/symbol n−3, slot/subframe/symbol n−2 and slot/subframe/symbol n−1, respectively.

For example, if the first RRC parameter is 4, and a nominal CG PUSCH occasion occurs in slot/subframe/symbol n, the UE may determine that four additional CG PUSCH occasions exist in slot/subframe/symbol n−4, slot/subframe/symbol n−3, slot/subframe/symbol n−2 and slot/subframe/symbol n−1, respectively.

In some implementations, a CG PUSCH occasion bundle may include one nominal CG PUSCH occasion, followed by nⱼᵢₜₜₑᵣ−1 or jitter additional CG PUSCH occasions before and after the nominal CG PUSCH occasion.

For example, if the first RRC parameter is 4, and a nominal CG PUSCH occasion occurs in slot/subframe/symbol n, the UE may determine additional CG PUSCH occasions exist in slot/subframe/symbol n−3, n−2, n−1, n+1, n+2, and n+3 respectively. For example, if the first RRC parameter is 4, and a nominal CG PUSCH occasion occurs in slot/subframe/symbol n, the UE may determine additional CG PUSCH occasions exist in slot/subframe/symbol n−4, n−3, n−2, n−1, n+1, n+2, n+3 and n+4 respectively.

In some implementations, the gap between each CG PUSCH occasion within a CG PUSCH occasion bundle may be determined by an offset value, e.g., nⱼᵢₜₜₑᵣ, as defined in the present disclosure.

For example, the unit of the offset value may be slot/subframe/symbol.

In some implementations, the gap between each CG PUSCH occasion within a CG PUSCH occasion bundle may be preconfigured in the UE (e.g., written in the specification).

In some implementations, if the first RRC parameter is a list of numbers and the k^{th} value in the list is denoted as n_{jitter,k}, and a nominal CG PUSCH occasion is in slot/subframe n, assuming the number of integers in the list is K, the UE may determine that K additional CG PUSCH occasion(s) exist(s) at instance(s) of time which is/are n_{jitter,k} slots/milliseconds/subframes/symbols before the nominal CG PUSCH occasion if n_{jitter,k}<0, or at an instance of time which is/are n_{jitter,k} slots/milliseconds/subframes/symbols after the nominal CG PUSCH occasion if n_{jitter,k} respectively.

For example, each entry in the first RRC parameter may only be larger than or equal to 0.

For example, each entry in the first RRC parameter may only be larger than 0.

For example, each entry in the first RRC parameter may only be less than or equal to 0.

For example, each entry in the first RRC parameter may only be less than 0.

For example, if the first RRC parameter is [−1, 2], and a nominal CG PUSCH occasion occurs at slot/subframe/symbol n, the UE may determine that two additional CG PUSCH occasions exist in slot/subframe/symbol n−1 and slot/subframe/symbol n+2, respectively.

In some implementations, if the first RRC parameter is a list of numbers and the k^{th} value in the list is denoted as n_{jitter,k}, and a nominal CG PUSCH occasion is in slot/subframe n, assuming the number of integers in the list is K (K≥0), the UE may determine that K additional CG PUSCH occasion(s) exist(s) at instance(s) of time which is/are n_{jitter,k} slots/milliseconds/subframes/symbols before the nominal CG PUSCH occasion and K additional CG PUSCH occasion(s) exist(s) at instance(s) of time which is/are n_{jitter,k} slots/milliseconds/subframes/symbols after the nominal CG PUSCH occasion, respectively.

For example, each entry in the first RRC parameter may only be larger than or equal to 0.

For example, each entry in the first RRC parameter may only be larger than 0.

For example, if the first RRC parameter is [1, 2], and a nominal CG PUSCH occasion occurs at slot/subframe/symbol n, the UE may determine that four additional CG PUSCH occasions exist in slot/subframe/symbol n−2, slot/subframe/symbol n−1, slot/subframe/symbol n+1 and slot/subframe/symbol n+2, respectively.

In some implementations, if the first RRC parameter is a list of integers, the UE may receive a DCI that activates the CG configuration, where the first field included in the DCI may indicate which integer provided by the first RRC parameter the UE may use.

In some implementations, if the number of integers provided by the first RRC parameter is K (K≥0), the k^{th} value in the list is denoted as n_{jitter,k}, the first field in the DCI indicates to the UE to use the i^{th} value provided by the first RRC parameter, and a nominal CG PUSCH occasion is in slot/subframe n, the UE may determine that more than one, e.g., n_{jitter,i}−1 or n_{jitter,i}, additional CG PUSCH occasions exist between an instance of time which is n_{jitter,i} slots/milliseconds/subframes/symbols before the nominal CG PUSCH occasion and the nominal CG PUSCH occasion.

In some implementations, if the number of integers provided by the first RRC parameter is K (K≥0), the k^{th} value in the list is denoted as n_{jitter,k}, the first field in the DCI indicates to the UE to use the i^{th} value provided by the first RRC parameter, and a nominal CG PUSCH occasion is in slot/subframe n, the UE may determine that more than one additional CG PUSCH occasions exist between an instance of time which is n_{jitter,i} slots/milliseconds/subframes/symbols after the nominal CG PUSCH occasion and the nominal CG PUSCH occasion.

For example, each integer in the list provided by the first RRC parameter may only be an integer larger than or equal to 0.

For example, each integer in the list provided by the first RRC parameter may only be an integer larger than 0.

For example, each integer in the list provided by the first RRC parameter may only be an integer less than or equal to 0.

For example, each integer in the list provided by the first RRC parameter may only be an integer less than 0.

In some implementations, a CG PUSCH occasion bundle may include one nominal CG PUSCH occasion, followed by n_{jitter,i}−1 or n_{jitter,i} additional CG PUSCH occasions after the nominal CG PUSCH occasion.

For example, if the first RRC parameter is [3, 4], and the first field included in the DCI that activates the CG configuration (e.g., the most recent one) indicates to the UE to use the second value provided by the first RRC parameter, and a nominal CG PUSCH occasion occurs in slot/subframe/symbol n, the UE may determine that three additional CG PUSCH occasions exist in slot/subframe/symbol n+1, slot/subframe/symbol n+2 and slot/subframe/symbol n+3, respectively.

For example, if the first RRC parameter is [1, 4], and the first field included in the DCI that activates the CG configuration (the most recently) indicates to the UE to use the second value provided by the first RRC parameter, and a nominal CG PUSCH occasion occurs in slot/subframe/symbol n, the UE may determine that four additional CG PUSCH occasions exist in slot/subframe/symbol n+1, slot/subframe/symbol n+2, slot/subframe/symbol n+3 and slot/subframe/symbol n+4, respectively.

In some implementations, a CG PUSCH occasion bundle may include n_{jitter,i}−1 or

CG PUSCH occasions, followed by the nominal CG PUSCH occasion (e.g., as the last CG PUSCH occasion within the CG PUSCH occasion bundle).

For example, if the first RRC parameter is [3, 4], and the first field included in the DCI that activates the CG configuration (e.g., the most recent one) indicates to the UE to use the second value provided by the first RRC parameter, and a nominal CG PUSCH occasion occurs in slot/subframe/symbol n, the UE may determine that three additional CG PUSCH occasions exist in slot/subframe/symbol n−3, slot/subframe/symbol n−2 and slot/subframe/symbol n−1, respectively.

For example, if the first RRC parameter is [3, 4], and the first field included in the DCI that activates the CG configuration (e.g., the most recent one) indicates to the UE to use the second value provided by the first RRC parameter, and a nominal CG PUSCH occasion occurs in slot/subframe/symbol n, the UE may determine that four additional CG PUSCH occasions exist in slot/subframe/symbol n−4, slot/subframe/symbol n−3, slot/subframe/symbol n−2 and slot/subframe/symbol n−1, respectively.

In some implementations, the gap between each CG PUSCH occasion within a CG PUSCH occasion bundle may be determined by an offset value, e.g., n_{jitter,i}, as defined in the present disclosure.

In some implementations, the gap between each CG PUSCH occasion within a CG PUSCH occasion bundle may be preconfigured in the UE (e.g., written in the specification).

In some implementations, if the first RRC parameter is a list of lists of numbers (e.g., each entry in the first RRC parameter is a list that contains one or more integers), the UE may receive a DCI that activates the CG configuration (e.g., the most recent CG configuration), where the first field included in the DCI may indicate which entry, provided by the first RRC parameter, the UE may use. If there are K values in the list indicated by the first field included in the DCI and the k^{th} value in the list is denoted as n_{jitter,k}, the UE may determine that K additional CG PUSCH occasion(s) exist(s) at instance(s) of time which is/are n_{jitter,k} slots/milliseconds/subframes/symbols before the nominal CG PUSCH occasion if n_{jitter,k}<0, or at an instance of time which is/are n_{jitter,k} slots/milliseconds/subframes/symbols after the nominal CG PUSCH occasion if n_{jitter,k}>0, respectively.

For example, each entry in each list provided by the first RRC parameter may only be larger than or equal to 0.

For example, each entry in each list provided by the first RRC parameter may only be larger than 0.

For example, each entry in each list provided by the first RRC parameter may only be less than or equal to 0.

For example, each entry in each list provided by the first RRC parameter may only be less than 0.

For example, if the first RRC parameter is [[−1, 2], [2, 3] ], and the first field included in the DCI that activated the CG configuration (e.g., the most recent one) indicates to the UE to use the first list provided by the first RRC parameter, and the nominal CG PUSCH occasion occurs at slot/subframe/symbol n, the UE may determine that two additional CG PUSCH occasions exist in slot/subframe/symbol n−1 and slot/subframe/symbol n+2, respectively.

In some implementations, if the first RRC parameter is a list of lists of numbers (e.g., each entry in the first RRC parameter is a list that contains one or more integers), the UE may receive a DCI that activates the CG configuration, where the first field included in the DCI may indicate which entry, provided by the first RRC parameter, the UE may use. Assuming there are K values in the list indicated by the first field included in the DCI and the k^{th} value in the list is denoted as n_{jitter,k}, the UE may determine that K additional CG PUSCH occasion(s) exist(s) at instance(s) of time which is/are n_{jitter,k} slots/milliseconds/subframes/symbols before the nominal CG PUSCH occasion and K additional CG PUSCH occasion(s) exist(s) at instance(s) of time which is/are n_{jitter,k} slots/milliseconds/subframes/symbols after the nominal CG PUSCH occasion, respectively.

For example, each entry in each list provided by the first RRC parameter may only be larger than or equal to 0.

For example, each entry in each list provided by the first RRC parameter may only be larger than 0.

For example, if the first RRC parameter is [[1, 2], [3, 4]], and the first field included in the DCI that activated the CG configuration (e.g., the most recent one) indicates to the UE to use the first list provided by the first RRC parameter, and a nominal CG PUSCH occasion occurs at slot/subframe/symbol n, the UE may determine that four additional CG PUSCH occasions exist in slot/subframe/symbol n−2, slot/subframe/symbol n−1, slot/subframe/symbol n+1 and slot/subframe/symbol n+2, respectively.

In some implementations, the first RRC parameter may be a bitmap.

In some implementations, after determining the transmission occasions (TOs) of a CG configuration, i.e., nominal and additional CG PUSCH occasions, based on the first RRC parameter (and the first field included in the DCI that activates the CG configuration (e.g., the most recent one)), the UE may perform a new transmission of a TB in one of the CG PUSCH occasions within a CG PUSCH bundle.

In some implementations, the CG PUSCH occasion in which a UE may perform a new transmission of a first TB may be a CG PUSCH occasion according to the time when a MAC PDU is generated by the UE.

In some implementations, the CG PUSCH occasion in which a UE may perform a new transmission of a first TB may be a CG PUSCH occasion according to the time when an XR-specific MAC PDU is generated by the UE, e.g., when an XR-specific MAC PDU is generated by the UE or at an offset from the time.

For example, the UE may determine that a MAC PDU is an XR-specific MAC PDU based on some XR-awareness information received from the higher layers (e.g., the application layer).

For example, the offset may be a pre-configured value.

For example, the offset may be a fixed value and may be specified in the specification.

In some implementations, if there is any pending XR-specific MAC PDU, the UE may transmit the XR-specific MAC PDU(s) using the resources provided in a nominal or an additional CG PUSCH occasion in the CG (e.g., with a higher priority than other MAC PDUs).

In some implementations, the CG PUSCH occasion in which a UE may perform a new transmission of a TB may be determined/selected by the UE implementation.

In some implementations, a UE may be provided with a second RRC parameter and/or may receive a DCI that includes a second field, where the second RRC parameter and/or the second field in the DCI may indicate whether or not the UE may perform a CG PUSCH repetition (e.g., a HARQ retransmission of a TB) in the CG PUSCH occasions other than the CG PUSCH occasion where the UE transmits an actual CG PUSCH (e.g., the TB).

In some implementations, if a UE is an XR-specific UE (e.g., the UE has XR capability), the UE may be provided with the second RRC parameter and/or the UE may receive a DCI that includes a second field.

In some implementations, if a UE transmits specific information to the NW/gNB, the UE may be provided with the second RRC parameter and/or the UE may receive a DCI that includes a second field.

For example, the specific information may be transmitted via an assistance information/UEAssistanceInformation IE (e.g., the assistance information for XR, for non-integer DRX cycle, and/or for DRX preference).

For example, the specific information may be transmitted via a UE capability information/UECapabilityInformation IE (e.g., the UE capability information for XR, for non-integer DRX cycle, and/or for DRX preference).

For example, the specific information may indicate the information for the XR traffic pattern/XR application/frame per second/periodicity for DRX/pose control information.

For example, the specific information may be transmitted via a MAC CE (e.g., an SR, a BSR, and/or an XR MAC CE).

In some implementations, if a UE is performing a procedure for XR, the UE may be provided with the second RRC parameter and/or the UE may receive a DCI that includes a second field.

In some implementations, if a UE receives a specific indication from the BS, the UE may be provided with the second RRC parameter and/or the UE may receive a DCI that includes a second field.

In some implementations, if a UE is configured with a specific configuration/IE, by the NW/gNB, the UE may be provided with the second RRC parameter and/or the UE may receive a DCI that includes a second field.

For example, the specific configuration may indicate a scheduling information for the XR traffic.

For example, the specific configuration may trigger an XR procedure.

For example, the value of a second RRC parameter may be a Boolean.

For example, a second RRC parameter may provide a value among two values.

For example, a second DCI field may be one-bit, i.e., the value (bit) may be “0” or “1”.

For example, a second RRC parameter may be provided per CG configuration, per BWP, per cell, or per cell group, etc. The UE may apply the value of the second RRC parameter in the CG configuration/BWP/cell/cell group where the second RRC parameter is configured.

In some cases, the DCI may be an activating DCI that activates a Type-2 CG configuration (e.g., the most recent one).

In some implementations, for a PUSCH transmissions with a Type 1 or Type 2 CG, or for a Type 1 or Type 2 PUSCH transmission with a configured grant, the number of (nominal) repetitions K to be applied to the transmitted TB is provided by an indexed row in TDRA table if numberOfRepetitions is present in the table; otherwise K is provided by the higher-layer-configured parameters repK. In some implementations, the maximum number of transmissions of a TB within a bundle of the configured grant is given by a parameter (e.g., REPETITION_NUMBER), where the parameter (e.g., REPETITION_NUMBER) is set to K.

It should be noted that the term “bundle” here may not have the same meaning as the term “CG PUSCH occasion bundle”.

In some implementations, for a Type 1 or Type 2 CG (e.g., for a Type 1 or Type 2 PUSCH transmission with a configured grant), a UE may perform a new transmission of a TB using the resources provided in a CG PUSCH occasion within a CG PUSCH occasion bundle. If a first specific condition, or for a Type 2 CG, the first specific condition and a second specific condition, are fulfilled, the UE may perform/trigger HARQ retransmission(s) of the TB. The HARQ retransmission(s) of the TB may be the PUSCH repetition(s) (e.g., PUSCH repetition Type A and/or PUSCH repetition Type B), in the resources provided in the remaining CG PUSCH occasion(s) that is later than the CG PUSCH occasion where the UE performs the new transmission of the TB within the CG PUSCH occasion bundle without waiting for feedback from previous CG PUSCH transmission according to the parameter (e.g., REPETITION_NUMBER) for a configured uplink grant.

For example, the first specific condition may include “the UE is provided with the second RRC parameter”.

For example, the first specific condition may include “the UE is provided with the second RRC parameter of a first value”.

For example, the first specific condition may include “the UE is provided with a second RRC parameter and the second RRC parameter indicates that the UE may perform HARQ retransmission(s) of a TB in the resources provided in the remaining CG PUSCH occasion(s) within a CG PUSCH occasion bundle”.

For example, the second specific condition may include “the second field included in the DCI that activates the CG configuration (e.g., the most recent one) indicates a first value, e.g., “1” or “0””.

For example, the second specific condition may include “the second field included in the DCI that activates the CG configuration (e.g., the most recent one) indicates that the UE may perform HARQ retransmission(s) of a TB in the resources provided in the remaining CG PUSCH occasion(s) within a CG PUSCH occasion bundle”.

In some implementations, the number of HARQ retransmissions of the TB the UE may perform may be determined by a parameter (e.g., REPETITION_NUMBER (K)) and/or the number of remaining CG PUSCH occasion(s) that is later than the CG PUSCH occasion where the UE performs the new transmission of the TB within the CG PUSCH occasion bundle (denoted by J).

For example, the number of HARQ retransmissions of the TB may be the larger number between the parameter (e.g., REPETITION_NUMBER (K)) and the number of remaining CG PUSCH occasion(s) that is later than the CG PUSCH occasion where the UE performs the new transmission of the TB within the CG PUSCH occasion bundle (e.g., max(K, J) or max(REPETITION_NUMBER, J)).

In some implementations, for a Type 1 or Type 2 CG, or for a Type 1 or Type 2 PUSCH transmission with a configured grant, a UE may perform a new transmission of a TB using the resources provided in a CG PUSCH occasion within a CG PUSCH occasion bundle. If a first specific condition, or for a Type 2 CG, the first specific condition and a second specific condition, are fulfilled, the UE may not perform/trigger any HARQ retransmission of the TB. The HARQ retransmission of the TB may be the PUSCH repetition(s) in the resources provided in the remaining CG PUSCH occasion(s) that is later than the CG PUSCH occasion where the UE performs the new transmission of the TB within the CG PUSCH occasion bundle without waiting for feedback from previous CG PUSCH transmission according to a parameter (e.g., REPETITION_NUMBER) for a configured uplink grant.

For example, the first specific condition may include “the UE is not provided with a second RRC parameter”.

For example, the first specific condition may include “the UE is provided with a second RRC parameter of a second value”.

For example, the first specific condition may include “the UE is provided with a second RRC parameter and the second RRC parameter indicates that the UE may not perform HARQ retransmission(s) of a TB in the resources provided in the remaining CG PUSCH occasion(s) within a CG PUSCH occasion bundle”.

For example, the second specific condition may include “the second field included in the DCI that activates the CG configuration (e.g., the most recent one) indicates a second value, e.g., “0” or “1””.

For example, the second specific condition may include “the second field included in the DCI that activates the CG configuration (e.g., the most recent one) indicates that the UE may not perform HARQ retransmission(s) of a TB in the resources provided in the remaining CG PUSCH occasion(s) within a CG PUSCH occasion bundle”.

In some implementations, for a PUSCH transmissions with a Type 1 or Type 2 CG, or for a Type 1 or Type 2 PUSCH transmission with a configured grant, the number of (nominal) CG PUSCH repetitions K to be applied to the transmitted TB is provided by an indexed row in TDRA table if numberOfRepetitions is present in the table; otherwise K is provided by the higher-layer-configured parameters repK. In some implementations, the maximum number of transmissions of a TB within a bundle of the configured grant is given by a parameter (e.g., REPETITION_NUMBER), where the parameter (e.g., REPETITION_NUMBER) is set to K.

In some implementations, for a Type 1 CG, if the higher layer parameter pusch-RepTypeIndicator in rrc-ConfiguredUplinkGrant is configured and set to “pusch-RepTypeB”, a PUSCH repetition type B may be applied; otherwise, a PUSCH repetition Type A may be applied.

In some implementations, for a Type 2 CG activated by DCI format 0_1, if pusch-RepTypeIndicatorDCI-0-1 is set to “pusch-RepTypeB”, the UE applies the PUSCH repetition Type B procedure when determining the time domain resource allocation; otherwise, the UE applies the PUSCH repetition Type A procedure when determining the time domain resource allocation.

In some implementations, for a Type 2 CG activated by the DCI format 0_2, if pusch-RepTypeIndicatorDCI-0-2 is set to “pusch-RepTypeB”, the UE applies the PUSCH repetition Type B procedure when determining the time domain resource allocation; otherwise, the UE applies the PUSCH repetition Type A procedure when determining the time domain resource allocation.

In some implementations, if a UE is provided with a first RRC parameter in a CG configuration or a BWP or a cell, the UE does not expect to be configured to apply the PUSCH repetition Type B for this CG configuration or the BWP or the cell.

In one example, for a Type 1 CG, a UE does not expect to be provided/configured with a first RRC parameter and pusch-RepTypeIndicator in rrc-ConfiguredUplinkGrant at the same time.

In one example, for a Type 1 CG, a UE does not expect to be provided/configured with a first RRC parameter and to set pusch-RepTypeIndicator to “pusch-RepTypeB” at the same time.

In some implementations, for a Type 2 CG activated by the DCI format 0_1, a UE does not expect to be provided/configured with a first RRC parameter and to set pusch-RepTypeIndicatorDCI-0-1 to “pusch-RepTypeB” at the same time.

In some implementations, for a Type 2 CG activated by the DCI format 0_2, a UE does not expect to be provided/configured with a first RRC parameter and to set pusch-RepTypeIndicatorDCI-0-2 to “pusch-RepTypeB” at the same time.

In some implementations, for a Type 1 or Type 2 PUSCH transmission with a configured grant, or for a Type 1 or Type 2 CG, if a UE is provided a first RRC parameter (e.g., in the CG configuration), additional CG PUSCH occasions may be configured/determined as described above. If the UE applies the PUSCH repetition Type A when determining the time domain resource allocation in the following, the UE may transmit the PUSCH repetitions of a TB in a number of consecutive slots after the CG PUSCH occasion in which the UE transmits the TB or the UE determines to transmit the TB.

In some implementations, any CG PUSCH repetition that overlaps with a nominal CG PUSCH occasion or an additional CG PUSCH occasion in a slot may be omitted.

In some implementations, any CG PUSCH repetition that overlaps with a part of nominal CG PUSCH occasion or a part of additional CG PUSCH occasion in a slot may be omitted or be cancelled.

In some implementations, a nominal CG PUSCH occasion or an additional CG PUSCH occasion in a slot that overlaps with a part of any CG PUSCH repetition may be omitted or be cancelled.

For example, the number of consecutive slots may be provided by numberOfRepetitions or repK, or be given by a parameter (e.g., REPETITION_NUMBER or K).

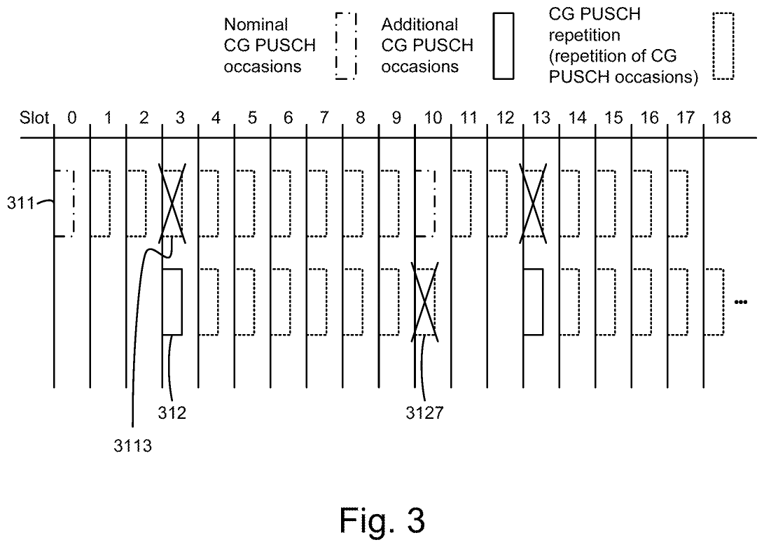

FIG. 3 is a diagram illustrating overlapping between CG PUSCH occasions and CG PUSCH repetitions, according to an example implementation of the present disclosure.

As shown in FIG. 3, the SCS is 15 kHz and the periodicity of the activated CG configuration is 10 ms (10 slots). The applied aggregation factor is 8, e.g., one nominal and additional CG PUSCH occasion and seven repetitions of CG PUSCH occasion for each of the nominal and additional CG PUSCH occasion. Within a periodicity (e.g., slot 0 to slot 9), the UE is configured by the first RRC parameter with an additional CG PUSCH occasion (e.g., 312) 3 slots after a nominal CG PUSCH occasion (e.g., 311). Under the given configuration, the third repetition of CG PUSCH occasion (e.g., 3113) for the nominal CG PUSCH occasion (e.g., 311) and the seventh repetition of CG PUSCH occasion (e.g., 3127) for the additional CG PUSCH occasion (e.g., 312) may be omitted/skipped. In the present example, two CG configurations may be in the same serving cell/BWP.

In some implementations, for a Type 1 or Type 2 PUSCH transmission with a configured grant, or for a Type 1 or Type 2 CG, if a UE is provided with a first RRC parameter (in the CG configuration), additional CG PUSCH occasions may be configured/determined as described above. If the UE applies PUSCH repetition Type B when determining the time domain resource allocation in the following, the UE may transmit PUSCH repetitions of a TB in a number of sets of consecutive symbols after the CG PUSCH occasion in which the UE transmit(s) the TB or the UE determines to transmit the TB.

In some implementations, any CG PUSCH repetition that overlaps with a nominal CG PUSCH occasion or an additional CG PUSCH occasion in a slot may be omitted or cancelled.

In some implementations, any CG PUSCH repetition that overlaps with a part of nominal CG PUSCH occasion or a part of additional CG PUSCH occasion in a slot may be omitted or be cancelled.

In some implementations, a nominal CG PUSCH occasion or an additional CG PUSCH occasion in a slot that overlaps with a part of any CG PUSCH repetition may be omitted or be cancelled.

For example, the number of sets of consecutive slots may be provided by numberOfRepetitions or repK, or be given by a parameter (e.g., REPETITION_NUMBER or K).

In some implementations, the UE may (additionally) determine the symbol(s) that overlap(s) with at least one symbol in an additional CG PUSCH occasion as invalid symbol(s) for the PUSCH repetition Type B transmission.

In some implementations, after determining the invalid symbol(s) for PUSCH repetition Type B transmission for each of the K nominal repetitions, the remaining symbols may be considered as potentially valid symbols for the PUSCH repetition Type B transmission.

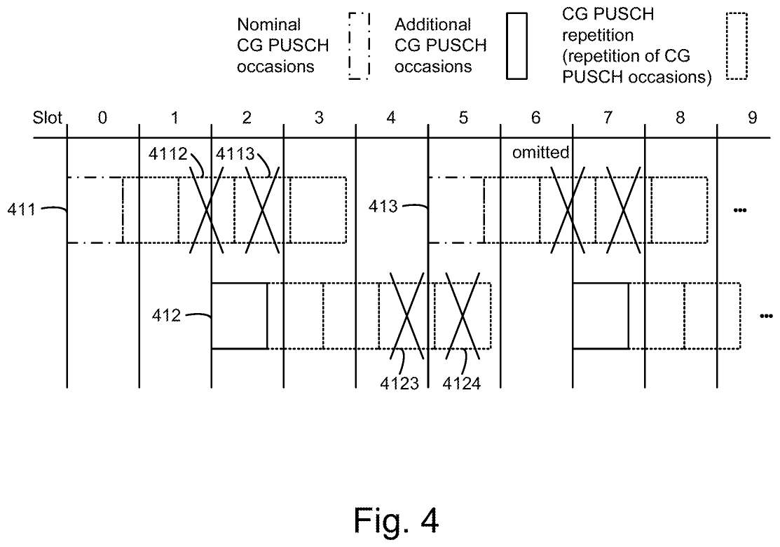

FIG. 4 is a diagram illustrating overlapping between CG PUSCH occasions and CG PUSCH repetitions, according to an example implementation of the present disclosure.

As shown in FIG. 4, the SCS is 15 kHz and the periodicity of the activated CG configuration is 5 ms (5 slots). The applied aggregation factor is 4, e.g., one nominal and one additional CG PUSCH occasion and four repetitions of CG PUSCH occasion for each of the nominal and the additional CG PUSCH occasions. Within a periodicity (e.g., slot 0 to slot 4), the UE is configured by the first RRC parameter with an additional CG PUSCH occasion (e.g., 412) 2 slots after a nominal CG PUSCH occasion (e.g., 411). Under the given configuration, the second repetition of CG PUSCH occasion (e.g., 4112) and the third repetition of CG PUSCH occasion (e.g., 4113) for the nominal CG PUSCH occasion (e.g., 411), and the third repetition of CG PUSCH occasion (e.g., 4123) and the fourth repetition of CG PUSCH occasion (e.g., 4124) for the additional CG PUSCH occasion (e.g., 412) may be omitted/skipped. In the present example, two CG configurations may be in the same serving cell/BWP. Since the second repetition of CG PUSCH occasion (e.g., 4112) and the third repetition of CG PUSCH occasion (e.g., 4113) overlap with an additional CG PUSCH occasion (e.g., 412), the second repetition of CG PUSCH occasion (e.g., 4112) and the third repetition of CG PUSCH occasion (e.g., 4113) may be omitted/skipped. Since the third repetition of CG PUSCH occasion (e.g., 4123) and the fourth repetition of CG PUSCH occasion (e.g., 4124) overlap with a nominal CG PUSCH occasion (e.g., 413), the third repetition of CG PUSCH occasion (e.g., 4123) and the fourth repetition of CG PUSCH occasion (e.g., 4124) may be omitted/skipped.

In some implementations, if numberOfRepetitions is provided in the TDRA table and numberOfRepetitions is not set to “n1”, and/or the repK provided in a Type 1 or Type 2 CG configuration is not “n1”, the UE may not expect to be provided a first RRC parameter in the CG configuration, and/or the UE may not apply numberOfRepetitions and/or repK to the CG configuration.

In some implementations, if the UE is provided with a first RRC parameter (e.g., in the CG configuration), the UE may not be expected or may not expect that numberOfRepetitions provided in the corresponding TDRA table is not set to “n1” and/or the repK provided in the CG configuration is not set to “n1”.

For configured uplink grants with harq-ProcID-Offset2, the HARQ Process ID associated with the first symbol of a UL transmission may be derived from the following equation:
HARQ Process ID=[floor(CURRENT_symbol/periodicity)] modulo nrofHARQ-Processes+harq-ProcID-Offset2,
where CURRENT_symbol=(SFN×numberOfSlotsPerFrame×numberOfSymbolsPerSlot+slot number in the frame×numberOfSymbolsPerSlot+symbol number in the slot), where numberOfSlotsPerFrame and numberOfSymbolsPerSlot refer to the number of consecutive slots per frame and the number of consecutive symbols per slot, respectively (e.g., as specified in 3GPP TS 38.211).

In some examples, the UE may first follow the above equation to derive the HPN/HARQ process ID of a nominal CG PUSCH occasion within a CG PUSCH occasion bundle. Then, any CG PUSCH transmitted in a CG PUSCH occasion within the CG PUSCH occasion bundle may have the same HPN/HARQ process ID as the HPN/HARQ process ID of the nominal CG PUSCH within the CG PUSCH occasion bundle.

In some examples, the UE may first follow the above equation to derive the HPN/HARQ process ID of a first CG PUSCH within a CG PUSCH occasion bundle. Then, any CG PUSCH transmitted in a CG PUSCH occasion within the CG PUSCH occasion bundle may have the same HPN/HARQ process ID as the HPN/HARQ process ID of the first CG PUSCH within the CG PUSCH occasion bundle.

In some implementations, a UE may be provided with a third RRC parameter and/or may receive a DCI that includes a third field, where the third RRC parameter and/or the third field in the DCI may indicate the number of TB s the UE may transmit within a CG PUSCH occasion bundle.

In some implementations, if a UE is an XR-specific UE (e.g., the UE has XR capability), the UE may be provided with the third RRC parameter and/or the UE may receive a DCI that includes a third field.

In some implementations, if a UE transmits specific information to the NW/gNB, the UE may be provided with the third RRC parameter and/or the UE may receive a DCI that includes a third field.

For example, the specific information may be transmitted via an assistance information/UEAssistanceInformation IE (e.g., the assistance information for XR, for non-integer DRX cycle, and/or for DRX preference).

For example, the specific information may be transmitted via a UE capability information/UECapabilityInformation IE (e.g., the UE capability information for XR, for non-integer DRX cycle, and/or for DRX preference).

For example, the specific information may indicate the information for the XR traffic pattern/XR application/frame per second/periodicity for DRX/pose control information.

For example, the specific information may be transmitted via a MAC CE (e.g., a SR, a BSR, and/or a XR MAC CE).

In some implementations, if a UE is performing a procedure for XR, the UE may be provided with the third RRC parameter and/or the UE may receive a DCI that includes a third field.

In some implementations, if a UE receives a specific indication from the BS, the UE may be provided with the third RRC parameter and/or the UE may receive a DCI that includes a third field.

In some implementations, if a UE is configured with a specific configuration/IE, by the NW/gNB, the UE may be provided with the third RRC parameter and/or the UE may receive a DCI that includes a third field.

For example, the specific configuration may indicate scheduling information for the XR traffic.

For example, the specific configuration may trigger an XR procedure.

For example, the third RRC parameter may be an integer.

For example, the third RRC parameter may provide a list of integers.

For example, the third DCI field may be one-bit, i.e., the value (bit) may be “0” or “1”.

For example, the third RRC parameter may be provided per CG configuration, per BWP, per cell, or per cell group, etc. The UE may apply the value of the third RRC parameter in the CG configuration/BWP/cell/cell group where the third RRC parameter is configured.

In some implementations, the DCI may be an activating DCI that activates a Type-2 CG configuration (e.g., the most recent one).

In some implementations, after determining the TOs of a CG configuration, e.g., the nominal and additional CG PUSCH occasions, based on the first RRC parameter (and the first field included in the DCI that activates the CG configuration (e.g., the most recent one)), the UE may perform new transmission(s) of one or more TB(s) in one or more CG PUSCH occasion(s) within a CG PUSCH bundle based on the third RRC parameter configured in at least one of the CG configuration or the third field included the DCI that activates the CG configuration.

In some implementations, if the third RRC parameter is not provided or the value provided by the third RRC parameter is 0, the UE may only transmit a TB within a CG PUSCH bundle and may follow the mechanisms described above.

In some implementations, if the third RRC parameter is provided and the value of the third RRC parameter is not 0, the UE may transmit a first TB in a CG PUSCH occasion.

In some implementations, if the third RRC parameter is provided and the value of the third RRC parameter is not 0, the UE may transmit a number of TB s in the remaining CG PUSCH occasion(s) that are later than the CG PUSCH occasion where the UE transmits the first TB within the CG PUSCH occasion bundle, where each TB may be transmitted in a consecutive CG PUSCH occasion.

In one example, if the first TB is transmitted in the i^{th} CG PUSCH occasion within a CG PUSCH occasion bundle, the k^{th} TB may be transmitted in the (i+k−1)^{th} CG PUSCH occasion within a CG PUSCH occasion bundle.

For example, if the first TB is transmitted in the i^{th} CG PUSCH occasion within a CG PUSCH occasion bundle, the second TB may be transmitted in the (i+1)^{th} CG PUSCH occasion within the CG PUSCH occasion bundle, and the third TB may be transmitted in the (i+2)^{th} CG PUSCH occasion within the CG PUSCH occasion bundle, and so on.

In some implementations, denoting the value given by the third RRC parameter as T and denoting the number of remaining CG PUSCH occasions that are later than the CG PUSCH occasion where the UE transmits the first TB within the CG PUSCH occasion bundle as L, the maximum number of TB s the UE may determine to transmit within the CG PUSCH occasion bundle may be determined by the smaller value between T and L+1, e.g., min(T, L+1).

In some implementations, the CG PUSCH occasion in which a UE may perform a new transmission of a first TB may be a CG PUSCH occasion according to the time when an XR-specific MAC PDU is generated by the UE, e.g., when an XR-specific MAC PDU is generated by the UE or at an offset from the time.

For example, the UE may determine that a MAC PDU is an XR-specific MAC PDU based on some XR-awareness information received from the higher layers (e.g., the application layer).

For example, the offset may be a pre-configured value.

For example, the offset may be a fixed value and may be specified in the specification.

In some implementations, if there is any pending XR-specific MAC PDU, the UE may transmit the XR-specific MAC PDU(s) using the resources provided in a nominal or an additional CG PUSCH occasion in the CG (e.g., with higher priority than other MAC PDUs).

In some implementations, the CG PUSCH occasion in which a UE may perform a new transmission of a first TB may be determined/selected by the UE implementation.

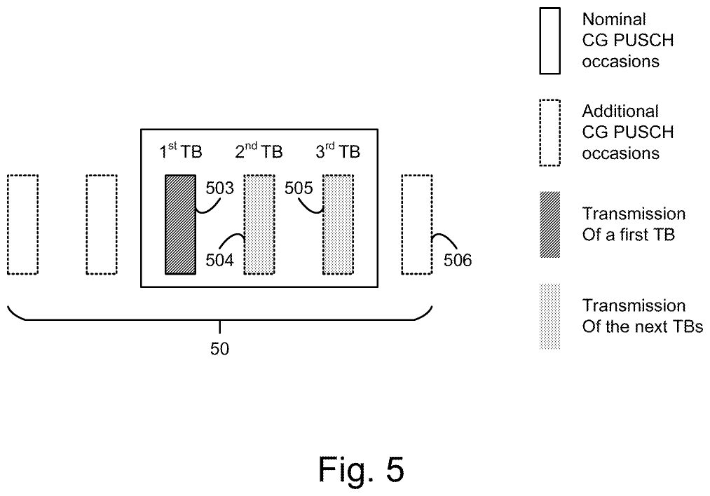

FIG. 5 is a diagram illustrating transmitting more than one TB s within a CG PUSCH occasion bundle, according to an example implementation of the present disclosure.

As shown in FIG. 5, the UE is provided with a third RRC parameter (e.g., for the CG configuration) and the value is 3 (T=3). The UE transmits a first TB in the third CG PUSCH occasion 503 (e.g., nominal) within a CG PUSCH occasion bundle 50. The number of remaining CG PUSCH occasions 504, 505, 506 that are later than the CG PUSCH occasion 503 where the UE transmits the first TB within the CG PUSCH occasion bundle 50 is 3 (L=3). Therefore, the maximum number of TBs the UE may transmit within the CG PUSCH occasion bundle 50 is min(T, L+1)=min(3, 4)=3. Therefore, when necessary, the UE may transmit a second TB in the fourth CG PUSCH occasion 504 within the CG PUSCH occasion bundle 50 and/or a third TB in the fifth CG PUSCH occasion 505 within the CG PUSCH occasion bundle 50.

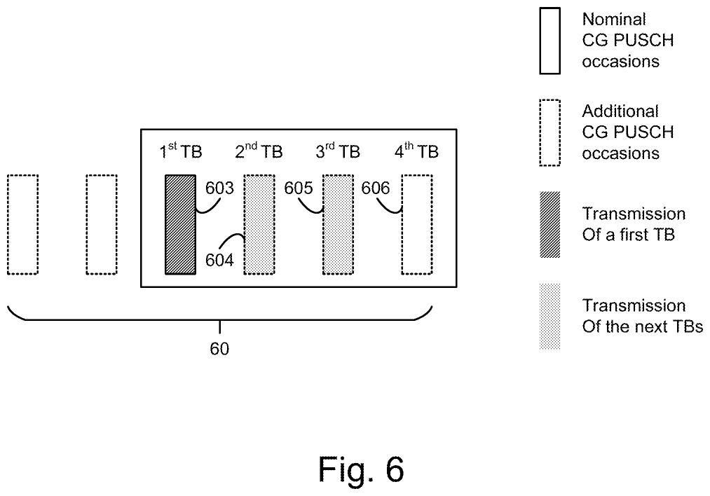

FIG. 6 is a diagram illustrating transmitting more than one TBs within a CG PUSCH occasion bundle, according to an example implementation of the present disclosure.

As shown in FIG. 6, the UE is provided with a third RRC parameter (for the CG configuration) and the value is 5 (T=5). The UE transmits a first TB in the third CG PUSCH occasion 603 (nominal) within a CG PUSCH occasion bundle 60. The number of remaining CG PUSCH occasions 604, 605, 606 that are later than the CG PUSCH occasion 603 where the UE transmits the first TB within the CG PUSCH occasion bundle 60 is 3 (L=3). Therefore, the maximum number of TBs the UE may transmit within the CG PUSCH occasion bundle 60 is min(T, L+1)=min(5, 4)=4. Therefore, when necessary, the UE may transmit a second TB in the fourth CG PUSCH occasion 604 within the CG PUSCH occasion bundle 60 and/or a third TB in the fifth CG PUSCH occasion 605 within the CG PUSCH occasion bundle 60, and/or a fourth TB in the sixth CG PUSCH occasion 606 within the CG PUSCH occasion bundle 60.

For the configured uplink grants with harq-ProcID-Offset2, the HARQ Process ID associated with the first symbol of a UL transmission may be derived from the following equation:
HARQ Process ID=[floor(CURRENT_symbol/periodicity)] modulo nrofHARQ-Processes+harq-ProcID-Offset2,
where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively (e.g., as specified in 3GPP TS 38.211).

In some implementations, if a UE is provided with a first RRC parameter in a CG configuration, additional CG PUSCH occasions may be configured/determined as described above. If the UE is further provided with a third RRC parameter (e.g., in the CG configuration), the UE may determine the HPN/HARQ process ID based on the third RRC parameter.

In some examples, the UE may first follow the above equation to derive the HPN/HARQ process ID of a nominal CG PUSCH occasion within a CG PUSCH occasion bundle.

In some implementations, the UE may determine the HPN/HARQ process ID of transmission of the first TB as the HPN/HARQ process ID for the nominal CG PUSCH occasion, the HPN/HARQ process ID for the nominal CG PUSCH occasion denoted as HPN nominal in the following.

In some implementations, the UE may determine the HPN/HARQ process ID of transmission of the k^{th} TB as HPNₙₒₘᵢₙₐₗ+k−1.

In some examples, the UE may first follow the above formula to determine the HPN/HARQ process ID of a first CG PUSCH within a CG PUSCH occasion bundle. Then any CG PUSCH transmitted in a CG PUSCH occasion within the CG PUSCH occasion bundle may have the same HPN/HARQ process ID as the HPN/HARQ process ID of the first CG PUSCH within the CG PUSCH occasion bundle.

For example, the third RRC parameter may be provided per CG configuration.

In some examples, if the UE is provided with a Time Division Duplexing (TDD) configuration(s) by the RRC layer, the UE may be indicated by at least one TDD configuration that some sets of symbols are used for DL only (e.g., DL symbols), some sets of symbols are used for UL only (e.g., UL symbols), and some sets of symbols may be used for UL and DL (e.g., flexible symbols). If at least one symbol of a (e.g., nominal or additional) CG PUSCH occasion within a CG PUSCH occasion bundle overlaps with any DL symbol indicated by an active TDD configuration, the CG PUSCH occasion may be omitted (e.g., the UE may not transmit a CG PUSCH in the CG PUSCH occasion).

For example, the TDD configuration(s) may be provided by tdd-UL-DL-ConfigurationCommon or tdd-UL-DL-ConfigurationDedicated.

In some implementations, the UE may not expect that a CG PUSCH occasion within a CG PUSCH occasion bundle overlaps with any CG PUSCH occasion (e.g., including additional CG PUSCH occasion(s) and the nominal CG PUSCH occasion) within another CG PUSCH occasion bundle.

In some implementations, the UE may not expect that a first CG PUSCH occasion bundle overlaps with a second CG PUSCH occasion bundle different from the first CG PUSCH occasion bundle.

For example, the UE may not expect that a CG PUSCH occasion within a first CG PUSCH occasion bundle overlaps with a CG PUSCH occasion within a second CG PUSCH occasion bundle different from the first CG PUSCH occasion bundle.

In some implementations, the UE may not expect to be configured a periodicity and a first RRC parameter for a CG configuration such that the periodicity is larger than the resulted length/span of a CG PUSCH occasion bundle in time domain.

For example, the resulted length/span of a CG PUSCH occasion bundle may be determined based on the provided first RRC parameter (and the first field included in the DCI that activates the CG configuration (e.g., the most recent one)), e.g., from the start of the first symbol of the first CG PUSCH occasion within the CG PUSCH occasion bundle to the end of the last symbol of the last CG PUSCH occasion within the CG PUSCH occasion bundle.

Before comparison, the periodicity and the first RRC parameter may need to be converted to the same unit.

For example, the periodicity may be provided by periodicity or periodicityExt-r16 in the CG configuration.

In some implementations, if the UE determines that a CG PUSCH occasion within a CG PUSCH occasion bundle overlaps with a slot boundary, the UE may not transmit a CG PUSCH in the CG PUSCH occasion.

In some implementations, if the UE determines that a first CG PUSCH occasion within a CG PUSCH occasion bundle overlaps with a second CG PUSCH occasion from a subsequent CG PUSCH occasion bundle, the UE may not transmit (e.g., the UE may ignore) a CG PUSCH in the first CG PUSCH occasion, or the UE may not transmit (e.g., the UE may ignore) a CG PUSCH in the second CG PUSCH occasion.

In some implementations, a CG PUSCH occasion bundle may be terminated after a number of CG PUSCH occasions within the CG PUSCH occasion bundle, or at the last CG PUSCH occasion bundle within the periodicity of the CG configuration, or from the starting symbol of the repetition that overlaps with a PUSCH with the same HARQ process scheduled by a DCI, whichever is reached first.

In some implementations, if a CG PUSCH occasion within a CG PUSCH occasion bundle and a PDSCH scheduled by a DCI are overlapped in the time domain, the UE may omit or cancel the CG PUSCH occasion and/or may transmit a PUSCH scheduled by the DCI.

For example, the DCI may be DCI format 0_0, DCI format 0_1, DCI format 0_2, DCI format 3_0 or DCI format 3_1, with CRC scrambled by C-RNTI, CS-RNTI, MCS-RNTI, SL-RNTI, SLCS-RNTI.

In some implementations, the UE may not expect to receive a DCI that schedules the PDSCH(s) overlapping any additional CG PUSCH occasion.

In some implementations, the UE may not expect to receive a DCI that schedules the PDSCH(s) overlapping any CG PUSCH occasion (e.g., including additional CG PUSCH occasions and nominal CG PUSCH occasions).

In some implementations, if a UE is provided by respective configuredGrantConfig with multiple CG configurations on a serving cell, the multiple CG configurations including the first (set of) CG configuration(s) that provide(s) the first RRC parameter(s) and the second (set of) CG configurations(s) that does not provide the first RRC parameter(s), the UE may not expect to receive the DCIs activating one or more CG configuration(s) of the first (set of) CG configurations and one or more CG configurations of the second (set of) CG configurations in a case that that the CG configuration(s) from the first (set of) CG configurations and the CG configuration(s) form the second (set of) CG configurations overlap in the time domain.

In some implementations, if a UE is provided by respective configuredGrantConfig with multiple CG configurations on a serving cell, the multiple CG configurations including first (set of) CG configuration(s) that provide(s) first RRC parameter(s) and second (set of) CG configurations(s) that does not provide the first RRC parameter(s), and the UE receives DCIs activating one or more CG configuration(s) from the first (set of) CG configurations and one or more CG configurations from the second (set of) CG configurations such that the CG configuration(s) from the first (set of) CG configurations and the CG configuration(s) form the second (set of) CG configurations overlap in time domain, for the overlapping CG PUSCH occasions, the UE may not receive CG PUSCH in the CG PUSCH occasions given by the CG configuration(s) of the second (set of) CG configurations, and/or the UE may only need to receive CG PUSCH in the CG PUSCH occasions given by the CG configuration(s) of the first (set of) CG configurations.

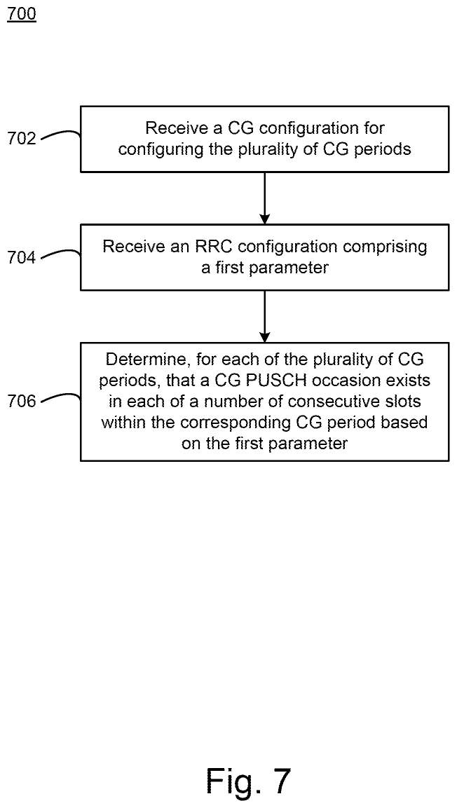

FIG. 7 is a flowchart of a method 700 for allowing more than one PUSCHs in each of a plurality of CG periods, according to an example implementation of the present disclosure.

It should be noted that although actions 702, 704 and 706 are illustrated as separate actions represented as independent blocks in FIG. 7, these separately illustrated actions should not be construed as necessarily order-dependent. The order in which the actions are performed in FIG. 7 is not intended to be construed as a limitation, and any number of the disclosed blocks may be combined in any order to implement the method, or an alternate method. Moreover, each of actions 702, 704 and 706 may be performed independently of other actions and may be omitted in some implementations of the present disclosure.

In action 702, the UE may receive a CG configuration from the BS for configuring a plurality of CG periods.

In some implementations, the CG configuration may be received via RRC signaling (e.g., from an RRC entity).

In some implementations, the CG configuration may be a Type 1 or Type 2 CG configuration for configuring the plurality of CG periods. Taking FIG. 3 as an example, slot 0 to slot 9 may be a first CG period of the configured plurality of CG periods, slot 10 to slot 19 may be a second period of the configured plurality of CG periods, and so on.

In a case that the CG configuration is a Type 2 CG configuration, a DCI may be subsequently received from the BS for activating the Type 2 CG configuration. The DCI may indicate an SLIV by a time domain resource assignment (TDRA) field, such that the UE may apply the SLIV to CG PUSCH occasions configured by the CG configuration.

In some implementations, the CG configuration may indicate a nominal CG PUSCH occasions in each of the plurality of CG periods.

For example, for a Type-1 CG, a first parameter in the CG configuration may indicate the length of a CG period; a second parameter in the CG configuration may indicate the timing starting offset used to determine the SFN and the slot number of the nominal CG PUSCH occasions; and a third parameter in the CG configuration may indicate the time-domain symbol allocation (e.g., the start symbol and the number of symbols, within the slots).

For example, for a Type-2 CG, a parameter in the CG configuration may indicate the length of a CG period. The DCI that activates the CG configuration may include at least two fields: a first field that indicates the slot numbers of the nominal CG PUSCH occasions; and a second field that indicates the time-domain symbol allocation (e.g., the start symbol and the number of symbols, within the slots).

In action 704, the UE may receive an RRC configuration including a first parameter from the BS.

In some implementations, the first parameter may be an integer.

In some implementations, the first parameter may be a floating-point number.

In some implementations, the first parameter may be a list of numbers. In a case that the length of the list is 1, the first parameter is a list containing one number.

In some implementations, the first parameter may be a list of integers. In a case that the length of the list is 1, the first parameter is a list containing an integer.

In some implementations, the first parameter may be a list of floating-point numbers. In a case that the length of the list is 1, the first parameter is a list containing a floating-point number.

In some implementations, the first parameter is contained in a CG configuration. For example, the RRC configuration may be the CG configuration received in action 702, and the first parameter is contained in the CG configuration.

In action 706, the UE may determine, for each of the plurality of CG periods, that a CG PUSCH occasion exists in each of a number of consecutive slots within the corresponding CG period based on the first parameter. Specifically, the number of consecutive slots is determined based on the first parameter.

In some implementations, the UE may determine the CG PUSCH occasions in addition to the nominal CG PUSCH occasions for the CG configuration according to the first parameter.

For example, the first parameter may be implemented according to the first RRC parameter as described above. The methods for determining the CG PUSCH occasions in addition to the nominal CG PUSCH occasions for the CG configuration according to the first RRC parameter are described above, therefore they are not described here again.

In some implementations, the UE may determine a HARQ process ID for consecutive CG PUSCH occasions within a CG period by sequentially adding one to the corresponding HARQ process ID. For example, if the HARQ process ID of the first (nominal) CG PUSCH occasion within a CG period is n, the HARQ process ID of the k^{th} CG PUSCH occasion within the CG period may be n+k−1. In a case that k=2, the k^{th} CG PUSCH occasion may be the second CG PUSCH occasion within the CG period or the first additional CG PUSCH occasion within the CG period.

In some implementations, the CG PUSCH occasion(s) corresponding to the CG configuration (e.g., configured by the CG configuration) may collide with other DL/UL source(s) in the time domain. For example, the UE may receive a TDD configuration from the BS and the TDD configuration may indicate at least one DL symbol that overlaps a CG PUSCH occasion (e.g., nominal or additional) corresponding to the CG configuration. In this case, the CG PUSCH occasion that overlaps the at least one DL symbol may be determined as invalid. In other words, resource(s) indicated in the TDD configuration has a higher priority than the CG PUSCH occasion(s) configured by the CG configuration.

Specifically, in a case that a UE determines an occasion as invalid, the UE omits the invalid occasion and/or determines not to perform a PUSCH transmission in the invalid occasion.

In some implementations, repetition(s) of the CG PUSCH occasion(s) corresponding to a CG configuration may be configured, for example, via a second parameter. In a case that a repetition overlaps with any CG PUSCH occasions corresponding to a CG configuration, the repetition may be determined as invalid. In other words, CG PUSCH occasion(s) corresponding to a CG configuration has a higher priority than the repetition(s) of the CG PUSCH occasions.

In some implementations, that CG PUSCH occasion(s) that are configured according to the first parameter (e.g., the first RRC parameter) may have a higher priority than the CG PUSCH occasion(s) that are configured according to the second parameter (e.g., the second RRC parameter).

For example, a UE may be configured with a first CG configuration and a second CG configuration, and may receive a specific parameter indicating a number of repetitions of a PUSCH occasion corresponding to the first CG configuration. In a case that a CG PUSCH occasion corresponding to the second CG configuration overlaps with a repetition of a CG PUSCH occasion corresponding to the first CG configuration, the UE may determine the repetition of the CG PUSCH occasion corresponding to the first CG configuration as invalid.

For example, a UE may be configured with a nominal CG PUSCH occasion and at least one additional CG PUSCH occasion by the first parameter and several repetitions of the nominal CG PUSCH occasion and the at least one additional CG PUSCH occasion. In a case that one of the several repetitions (e.g., of the nominal CG PUSCH occasion) overlaps with one of the at least one additional CG PUSCH occasion, the UE may determine the one of the several repetitions (e.g., of the nominal CG PUSCH occasion) as invalid.

For example, the second parameter may be implemented according to the second RRC parameter as described above. The methods for configuring repetition(s) for the CG PUSCH occasion(s) corresponding to a CG configuration according to the second RRC parameter are described above, therefore they are not repeated here again.

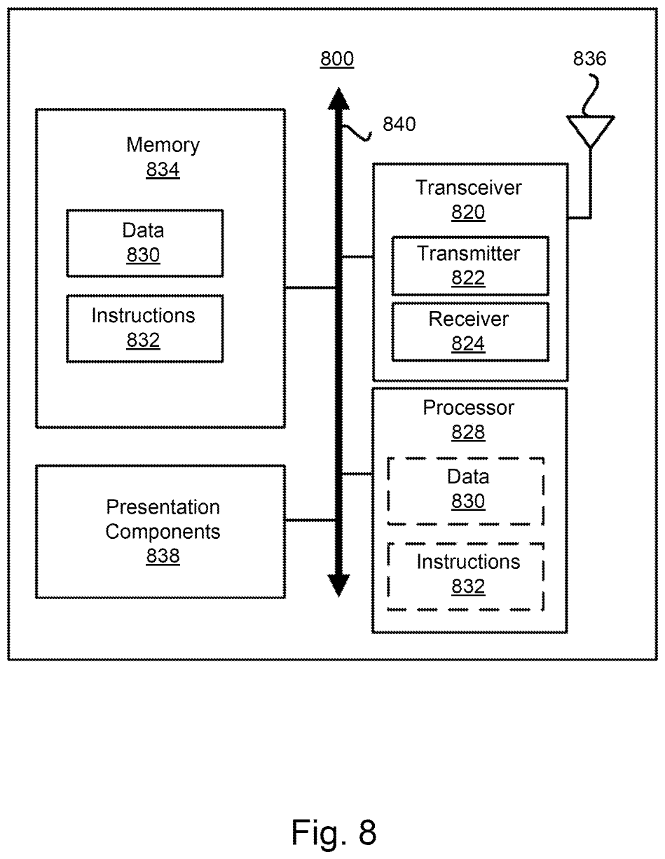

FIG. 8 is a block diagram illustrating a node 800 for wireless communication, according to an example implementation of the present disclosure. As illustrated in FIG. 8, a node 800 may include a transceiver 820, a processor 828, a memory 834, one or more presentation components 838, and at least one antenna 836. The node 800 may also include a radio frequency (RF) spectrum band module, a BS communications module, a NW communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including, but not limited to, usable, non-usable and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable instructions 832 (e.g., software codes or programs) that are configured to, when executed, cause the processor 828 to perform various functions disclosed herein, for example, with reference to FIGS. 1 through 7. Alternatively, the instructions 832 may not be directly executable by the processor 828 but may be configured to cause the node 800 (e.g., when compiled and executed) to perform various functions disclosed herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 834, and information transmitted and received via the transceiver 820, the baseband communications module, and/or the NW communications module. The processor 828 may also process information to send to the transceiver 820 for transmission via the antenna 836 to the NW communications module for transmission to a Core Network (CN).

One or more presentation components 838 may present data indications to a person or another device. Examples of presentation components 838 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

What is claimed is:

1. A method performed by a user equipment (UE) for allowing more than one physical uplink shared channels (PUSCHs) in each of a plurality of configured grant (CG) periods, the method comprising:
receiving, from a base station (BS), a CG configuration for configuring the plurality of CG periods;
receiving, from the BS, a radio resource control (RRC) configuration comprising a first parameter; and
determining, for each of the plurality of CG periods, that a CG PUSCH occasion exists in each of a number of consecutive slots within the corresponding CG period, wherein the number of consecutive slots is determined based on the first parameter.

2. The method of claim 1, further comprising:
receiving, from the BS, downlink control information (DCI) for activating the CG configuration, the DCI indicating a start and length indicator value (SLIV) included in a time domain resource assignment (TDRA) field; and
applying the SLIV to each CG PUSCH occasion.

3. The method of claim 1, further comprising:
determining a hybrid automatic repeat request (HARQ) process identifier (ID) of a second CG PUSCH occasion within one of the plurality of CG periods by incrementing a HARQ process ID of a first CG PUSCH occasion by one, wherein the first CG PUSCH is within the one of the plurality of CG periods and is before the second CG PUSCH occasion.

4. The method of claim 1, further comprising:
receiving, from the BS, a time division duplexing (TDD) configuration; and
determining, in a case that a certain CG PUSCH occasion within one of the plurality of CG periods overlaps with at least one DL symbol indicated by the TDD configuration, that the certain CG PUSCH occasion is invalid.

5. The method of claim 1, wherein the first parameter is in a form of an integer.

6. The method of claim 1, further comprising:
receiving, from the BS, a second parameter indicating a number of repetitions of a PUSCH occasion that is not associated with the CG configuration; and
determining, in a case that one of the number of repetitions of the PUSCH occasion overlaps with the CG PUSCH occasion corresponding to the CG configuration, that the one of the number of repetitions of the PUSCH occasion is invalid.

7. The method of claim 1, further comprising:
receiving, from the BS, a second parameter indicating a number of repetitions of the CG PUSCH occasion corresponding to the CG configuration; and
determining, in a case that a first CG PUSCH occasion corresponding to the CG configuration overlaps with one of a number of repetitions of a second CG PUSCH occasion corresponding to the CG configuration, that the one of the number of repetitions of the second CG PUSCH occasion is invalid.

8. The method of claim 1, wherein in a case that a CG PUSCH occasion within the one of the plurality of CG periods is invalid, omitting the invalid CG PUSCH occasion and determining not to perform a PUSCH transmission in the invalid CG PUSCH occasion.

9. A User Equipment (UE) for allowing more than one physical uplink shared channels (PUSCHs) in each of a plurality of configured grant (CG) periods, the UE comprising:
one or more processors; and
at least one memory coupled to at least one of the one or more processors, wherein the at least one memory stores one or more computer-executable instructions that, when executed by the at least one of the one or more processors, cause the UE to:
receive, from a base station (BS), a CG configuration for configuring the plurality of CG periods;
receive, from the BS, a radio resource control (RRC) configuration comprising a first parameter; and
determine, for each of the plurality of CG periods, that a CG PUSCH occasion exists in each of a number of consecutive slots within the corresponding CG period, wherein the number of consecutive slots is determined based on the first parameter.

10. The UE of claim 9, wherein the one or more computer-executable instructions, when executed by the at least one of the one or more processors, further cause the UE to:
receive, from the BS, downlink control information (DCI) for activating the CG configuration, the DCI indicating a start and length indicator value (SLIV) included in a time domain resource assignment (TDRA) field; and
apply the SLIV to each CG PUSCH occasion.

11. The UE of claim 9, wherein the one or more computer-executable instructions, when executed by the at least one of the one or more processors, further cause the UE to:
determine a hybrid automatic repeat request (HARQ) process identifier (ID) of a second CG PUSCH occasion within one of the plurality of CG periods by incrementing a HARQ process ID of a first CG PUSCH occasion by one, wherein the first CG PUSCH is within the one of the plurality of CG periods and is before the second CG PUSCH occasion.

12. The UE of claim 9, wherein the one or more computer-executable instructions, when executed by the at least one of the one or more processors, further cause the UE to:
receive, from the BS, a time division duplexing (TDD) configuration; and
determine, in a case that a certain CG PUSCH occasion within one of the plurality of CG periods overlaps with at least one DL symbol indicated by the TDD configuration, that the certain CG PUSCH occasion is invalid.

13. The UE of claim 9, wherein the first parameter is in a form of an integer.

14. The UE of claim 9, wherein the one or more computer-executable instructions, when executed by the at least one of the one or more processors, further cause the UE to:
receive, from the BS, a second parameter indicating a number of repetitions of a PUSCH occasion that is not associated with the CG configuration; and
determine, in a case that one of the number of repetitions of the PUSCH occasion overlaps with the CG PUSCH occasion corresponding to the CG configuration, that the one of the number of repetitions of the PUSCH occasion is invalid.

15. The UE of claim 9, wherein the one or more computer-executable instructions, when executed by the at least one of the one or more processors, further cause the UE to:
receive, from the BS, a second parameter indicating a number of repetitions of the CG PUSCH occasion corresponding to the CG configuration; and
determine, in a case that a first CG PUSCH occasion corresponding to the CG configuration overlaps with one of a number of repetitions of a second CG PUSCH occasion corresponding to the CG configuration, that the one of the number of repetitions of the second CG PUSCH occasion is invalid.

16. The UE of claim 9, wherein the one or more computer-executable instructions, when executed by the at least one of the one or more processors, further cause the UE to:
in a case that a CG PUSCH occasion within the one of the plurality of CG periods is invalid, omit the invalid CG PUSCH occasion and determine not to perform a PUSCH transmission in the invalid CG PUSCH occasion.

17. A base station (BS) for allowing more than one physical uplink shared channels (PUSCHs) in each of a plurality of configured grant (CG) periods, the BS comprising:
one or more processors; and
at least one memory coupled to at least one of the one or more processors, wherein the at least one memory stores one or more computer-executable instructions that, when executed by the at least one of the one or more processors, cause the BS to:
transmit, to a user equipment (UE), a CG configuration for configuring the plurality of CG periods; and
transmit, to the UE, a radio resource control (RRC) configuration comprising a first parameter, wherein:
the first parameter indicates a number of consecutive slots, such that for each of the plurality of CG periods, a CG PUSCH occasion exists in each of the number of consecutive slots within the corresponding CG period.

18. The BS of claim 17, wherein the one or more computer-executable instructions, when executed by the at least one of the one or more processors, further cause the BS to:
transmit, to the UE, downlink control information (DCI) for activating the CG configuration, the DCI indicating a start and length indicator value (SLIV) included in a time domain resource assignment (TDRA) field.

19. The BS of claim 17, wherein the one or more computer-executable instructions, when executed by the at least one of the one or more processors, further cause the BS to:
determine a hybrid automatic repeat request (HARQ) process identifier (ID) of a second CG PUSCH occasion within one of the plurality of CG periods by incrementing a HARQ process ID of a first CG PUSCH occasion by one, wherein the first CG PUSCH is within the one of the plurality of CG periods and is before the second CG PUSCH occasion.

20. The BS of claim 17, wherein the one or more computer-executable instructions, when executed by the at least one of the one or more processors, further cause the BS to:
transmit, to the UE, a time division duplexing (TDD) configuration; and
determine, in a case that a certain CG PUSCH occasion within one of the plurality of CG periods overlaps with at least one DL symbol indicated by the TDD configuration, not to receive the certain CG PUSCH occasion.
